(19) United States
(12) Patent Application Publication
(10) Pub. No.: US 2026/0172174 A1
(43) Pub. Date: Jun. 18, 2026

(54) METHOD AND APPARATUS FOR BEAM HOPPING IN NON TERRESTRIAL NETWORK

(71) Applicant: Electronics and Telecommunications Research Institute, Daejeon (KR)

(72) Inventor: Hee Wook KIM, Daejeon (KR)

(21) Appl. No.: 19/181,106

(22) Filed: Apr. 16, 2025

(30) Foreign Application Priority Data
Apr. 16, 2024 (KR) 10-2024-0050894

(51) Int. Cl. H04L 5/00

(52) U.S. Cl. CPC H04L 5/0048

(57) ABSTRACT

A method of a user equipment (UE) may comprise: receiving, from a base station, a first message including information indicating a cell discontinuous transmission (DTX) of a satellite, information indicating a first non-active duration of a first beam formed by the satellite, and information indicating a first active duration of the first beam; identifying whether a current time is within the first non-active duration based on the first message; and in response to the current time being a time of transitioning from the first active duration to the first non-active duration, configuring not to receive control information and traffic from the base station, wherein the first non-active duration is a duration in which the first beam is in an off state, and the first active duration is a duration in which the first beam is in an active traffic state.

### CROSS-REFERENCE TO RELATED APPLICATIONS

This application claims priority to Korean Patent Application No. 10-2024-0050894, filed on Apr. 16, 2024, with the Korean Intellectual Property Office (KIPO), the entire contents of which are hereby incorporated by reference.

### BACKGROUND

### 1. Technical Field

The present disclosure relates to a communication technique for a non-terrestrial network, and more particularly, to a beam hopping technique in a non-terrestrial network.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication network may provide communication services to terrestrial terminals located on the ground, and thus may be referred to as a terrestrial network. Recently, there has been a growing demand for communication services not only for terrestrial terminals but also for unmanned aerial vehicles, satellites, and other platforms located in non-terrestrial environments. To address this, techniques for a non-terrestrial network (NTN) are being discussed in the 3GPP.

In general, to improve system performance in an NTN system such as a satellite system, a beam hopping method is used. A satellite beam may refer to a beam formed by a satellite directed toward a terrestrial communication node. The beam hopping method used in the satellite system may be referred to as a satellite beam hopping method (or technique). When the satellite beam hopping method is used, each of satellite beams formed by the satellite may be controlled by the network. The satellite beams formed by the satellite may be subject to a continuous and repetitive beam activation pattern controlled by the network (or base station or satellite). The network may select beams to be activated, allowing the satellite to concentrate its beam(s) on an area where satellite resources are needed, thereby enhancing the overall performance of the satellite system. When the satellite in the NTN system uses multiple beams, the beam hopping technique may be required to improve the network performance.

### SUMMARY

The present disclosure for resolving the above-described problems is directed to providing a method and apparatus for beam hopping of a satellite using multiple beams in an NTN.

A method of a user equipment (UE), according to an exemplary embodiment of the present disclosure, may comprise: receiving, from a base station, a first message including information indicating a cell discontinuous transmission (DTX) of a satellite, information indicating a first non-active duration of a first beam formed by the satellite, and information indicating a first active duration of the first beam; identifying whether a current time is within the first non-active duration based on the first message; and in response to the current time being a time of transitioning from the first active duration to the first non-active duration, configuring not to receive control information and traffic from the base station, wherein the first non-active duration is a duration in which the first beam is in an off state, and the first active duration is a duration in which the first beam is in an active traffic state.

The information indicating the first non-active duration may include a first time for transitioning from the first active duration to the first non-active duration and a first period for maintaining the first non-active duration, and the information indicating the first active duration may include a second time for transitioning from the first non-active duration to the first active duration and information on a second period for maintaining the first active duration.

The method may further comprise: in response to the current time being a time of transitioning from the first non-active duration to the first active duration, configuring to receive control information and traffic from the base station.

The method may further comprise: in response to the first message including information indicating a cell discontinuous reception (DRX) for the first beam, identifying whether the current time is a time of transitioning from the first active duration to the first non-active duration; and in response to the current time being a time of transitioning from the first active duration to the first non-active duration, configuring not to perform an initial access procedure through a random access channel (RACH), transmission in a configured grant (CG) resource configured by the base station, transmission of a scheduling request (SR), periodic channel state information (CSI) reporting, semi-persistent CSI reporting, periodic sounding reference signal (SRS) transmission, and semi-persistent SRS transmission.

The method may further comprise: in response to the current time being a time of transitioning from the first non-active duration to the first active duration, configuring to perform an initial access procedure through a RACH, transmission in a CG resource configured by the base station, transmission of an SR, periodic CSI reporting, semi-persistent CSI reporting, periodic SRS transmission, and semi-persistent SRS transmission.

The method may further comprise: in response to the first message further including information indicating a second non-active duration of the first beam, identifying whether the current time is a time of transitioning from the first active duration to the second non-active duration; and in response to the current time being a time of transitioning from the first active duration to the second non-active duration, configuring to receive only control information from the base station, wherein the second non-active duration is a duration in which the first beam transmits only a common message, and the information indicating the second non-active duration includes a third time for transitioning from the first active duration to the second non-active duration and information on a third period for maintaining the second non-active duration.

The method may further comprise: in response to the current time being a time of transitioning from the second non-active duration to the first active duration, configuring to receive control information and traffic from the base station,

The method may further comprise: in response to the first message including information indicating a cell DRX of the first beam and information indicating a second non-active duration of the first beam, identifying whether the current time is a time of transitioning from the first active duration to the second non-active duration; and in response to the current time being a time of transitioning from the first active duration to the second non-active duration, configuring not to perform transmission on a CG resource configured by the base station, wherein the second non-active duration is a duration in which the first beam transmits only a common message, and the information indicating the second non-active duration includes a fourth time for transitioning from the first active duration to the second non-active duration and information on a fourth period for maintaining the second non-active duration.

The method may further comprise: in response to the first message including information indicating a second active duration of the first beam, identifying whether the current time is a time of transitioning from the first non-active duration to the second active duration; and in response to the current time being a time of transitioning from the first non-active duration to the second active duration, configuring to perform synchronization signal block (SSB) reception, system information block (SIB) reception, paging, physical downlink control channel (PDCCH) and semi-persistent scheduling (SPS) monitoring, wherein the second active duration is a duration in which the first beam transmits only a common message, and the information indicating the second active duration includes a fifth time for transitioning from the first non-active duration to the second active duration and information on a fifth period for maintaining the second active duration.

The method may further comprise: in response to the first message including information indicating a cell DRX of the first beam and information indicating a second active duration of the first beam, identifying whether the current time is a time of transitioning from the first non-active duration to the second active duration; and in response to the current time being a time of transitioning from the first non-active duration to the second active duration, configuring to perform an initial access procedure using a RACH, SR transmission, periodic CSI reporting, semi-persistent CSI reporting, periodic SRS transmission, and semi-persistent SRS reporting, wherein the second active duration is a duration in which the first beam transmits only a common message, and the information indicating the second active duration includes a fifth time of transitioning from the first non-active duration to the second active duration and information on a fifth period for maintaining the second active duration.

A method of a base station, according to an exemplary embodiment of the present disclosure, may comprise: transmitting, to a user equipment (UE), a first message including information indicating a cell discontinuous transmission (DTX) of a satellite, information indicating a first non-active duration of a first beam formed by the satellite, and information indicating a first active duration of the first beam; turning off the first beam when transitioning from the first active duration to the first non-active duration; and transmitting control information and traffic to the UE through the first beam when transitioning from the first non-active duration to the first active duration, wherein the first non-active duration is a duration in which the first beam is in an off state, and the first active duration is a duration in which the first beam is in an active traffic state.

The information indicating the first non-active duration may include a first time for transitioning from the first active duration to the first non-active duration and a first period for maintaining the first non-active duration, and the information indicating the first active duration may include a second time for transitioning from the first non-active duration to the first active duration and information on a second period for maintaining the first active duration.

The method may further comprise: transmitting only control information to the UE when transitioning from the first active duration to a second non-active duration, wherein the first message may further include information indicating the second non-active duration for the first beam, and the information indicating the second non-active duration may include a third time for transitioning from the first active duration to the second non-active duration and information on a third period for maintaining the second non-active duration.

The method may further comprise: receiving uplink signals from the UE, excluding an uplink signal in a CG resource configured by the base station, when transitioning from the first active duration to the second non-active duration, wherein the first message may further include information indicating a cell DRX of the first beam.

The method may further comprise: transmitting an SSB, an SIB, paging, a PDCCH, and an SPS through the first beam after transitioning from the first non-active duration to a second active duration, wherein the first message may further include information indicating the second active duration, and the information indicating the second active duration may include a fourth time for transitioning from the first active duration to the second active duration and information on a fourth period for maintaining the second active duration.

A user equipment (UE), according to an exemplary embodiment of the present disclosure, may comprise: at least one processor, wherein the at least one processor may cause the UE to perform: receiving, from a base station, a first message including information indicating a cell discontinuous transmission (DTX) of a satellite, information indicating a first non-active duration of a first beam formed by the satellite, and information indicating a first active duration of the first beam; identifying whether a current time is within the first non-active duration based on the first message; and in response to the current time being a time of transitioning from the first active duration to the first non-active duration, configuring not to receive control information and traffic from the base station, wherein the first non-active duration is a duration in which the first beam is in an off state, and the first active duration is a duration in which the first beam is in an active traffic state.

The information indicating the first non-active duration may include a first time for transitioning from the first active duration to the first non-active duration and a first period for maintaining the first non-active duration, and the information indicating the first active duration may include a second time for transitioning from the first non-active duration to the first active duration and information on a second period for maintaining the first active duration.

The at least one processor may further cause the UE to perform: in response to the current time being a time of transitioning from the first non-active duration to the first active duration, configuring to receive control information and traffic from the base station.

The at least one processor may further cause the UE to perform: in response to the first message including information indicating a cell discontinuous reception (DRX) for the first beam, identifying whether the current time is a time of transitioning from the first active duration to the first non-active duration; and in response to the current time being a time of transitioning from the first active duration to the first non-active duration, configuring not to perform an initial access procedure through a random access channel (RACH), transmission in a configured grant (CG) resource configured by the base station, transmission of a scheduling request (SR), periodic channel state information (CSI) reporting, semi-persistent CSI reporting, periodic sounding reference signal (SRS) transmission, and semi-persistent SRS transmission.

The at least one processor may further cause the UE to perform: in response to the current time being a time of transitioning from the first non-active duration to the first active duration, configuring to perform an initial access procedure through a RACH, transmission in a CG resource configured by the base station, transmission of an SR, periodic CSI reporting, semi-persistent CSI reporting, periodic SRS transmission, and semi-persistent SRS transmission.

According to exemplary embodiments of the present disclosure, when a network energy saving (NES) technique is applied in an NTN, a base station, satellite, and UE can communicate according to a cell DTX and/or cell DRX mechanism that considers a state of each beam footprint that the satellite can form. Accordingly, the UE can maintain service continuity based on a DTX pattern and/or DRX pattern. In addition, in the case of a low Earth orbit (LEO) satellite-based NTN, the UE can identify beam hopping pattern information in advance, even during frequent handovers caused by satellite movement, thereby not only avoiding unnecessary power consumption but also preventing occurrence of a radio link failure (RLF).

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a flowchart illustrating a UE-side operation in the cell DTX scheme, according to the first exemplary embodiment of the present disclosure.

FIG. 5 is a flowchart illustrating a UE-side operation in the cell DRX scheme, according to the first exemplary embodiment of the present disclosure.

FIG. 6 is a flowchart illustrating a UE-side operation in the cell DTX scheme, according to the second exemplary embodiment of the present disclosure.

FIG. 7 is a flowchart illustrating a UE-side operation in the cell DRX scheme, according to the second exemplary embodiment of the present disclosure.

FIG. 8 is a flowchart illustrating a UE-side operation in the cell DTX scheme, according to the third exemplary embodiment of the present disclosure.

FIG. 9 is a flowchart illustrating a UE-side operation in the cell DRX scheme, according to the third exemplary embodiment of the present disclosure.

FIG. 10 is a flowchart illustrating a UE-side operation in the cell DTX scheme, according to the fourth exemplary embodiment of the present disclosure.

FIG. 11 is a flowchart illustrating a UE-side operation in the cell DRX scheme, according to the fourth exemplary embodiment of the present disclosure.

FIG. 12 is a flowchart illustrating a method of configuring information for DTX and DRX operations based on the NES scheme for NTN satellite beams.

FIG. 13 is a flowchart illustrating a method for DTX and DRX operations of a UE under NES application.

FIG. 14 is a flowchart illustrating operations for a base station to configure information to be provided to a UE according to a beam hopping scheme in an NTN.

FIG. 15 is a flowchart illustrating a first exemplary embodiment of an operation for an NTN base station to configure information to be provided for channel estimation of a UE according to a beam hopping scheme.

FIG. 16 is a flowchart illustrating a second exemplary embodiment of an operation for an NTN base station to configure information to be provided for channel estimation of a UE according to a beam hopping scheme.

FIG. 17 is a flowchart illustrating a third exemplary embodiment of an operation for an NTN base station to configure information to be provided for channel estimation of a UE according to a beam hopping scheme.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specifications exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), and/or a 5G communication network (e.g. new radio (NR) communication network). The 4G communication network and 5G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

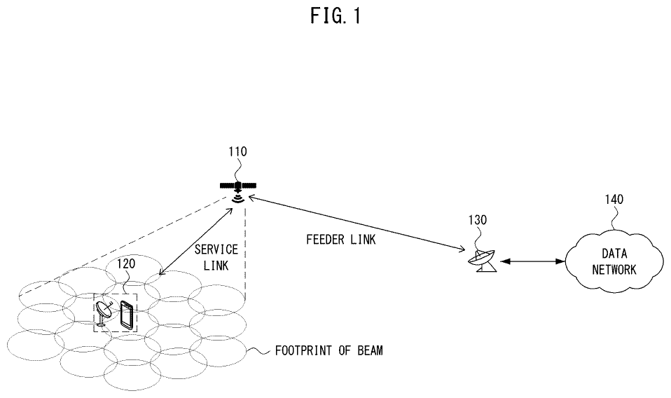

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

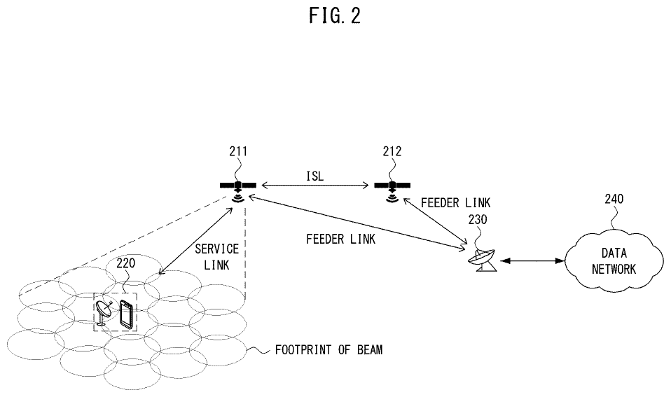

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

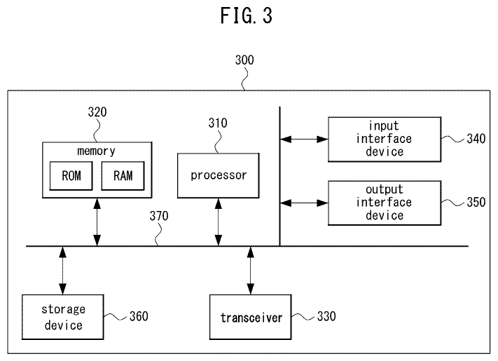

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as Dscenario C1′. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D32’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the | | |
| minimum elevation angle | | |
| Maximum round trip delay | Scenario A: 541.46 ms | Scenario C: (transparent |
| (RTD) (only propagation | (service and feeder links) | payload: service and feeder links) |
| delay) | Scenario B: 270.73 ms | −5.77 ms (altitude of 60 0 km) |
| | (only service link) | −41.77 ms (altitude of 1,200 km) |
| | | Scenario D: (regenerative |
| | | payload: only service link) |
| | | −12.89 ms (altitude of 600 km) |
| | | −20.89 ms (altitude of 1,200 km) |
| Maximum delay variation | 16 ms | 4.44 ms (altitude of 600 km) |
| within a single beam | | 6.44 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C | | Scenario D | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface between | (worst case) | | | | | |
| base station and UE | | | | | | |
| Minimum RTD in a | 477.14 ms | 238.57 ms | 8 | ms | 4 | ms |

radio interface between
base station and UE

Meanwhile, the reception coverages of the beams illustrated in FIG. 1 and FIG. 2 may be referred to as footprints of the beams. An NTN system has been defined by the 3GPP, one of the mobile communication technology standards, and the 3GPP NTN technical specifications assume the following three states for the beam footprints.

(A) First state N1: The first state N1 may refer to a state in which the beam footprints are in an off state. Therefore, in the first state, the beam footprints do not provide any signal. In other words, areas corresponding to the beam footprints in the first state may be areas where satellite services are not provided.

(B) Second state N2: The second state N2 may refer to a ‘common message only’ state for the beam footprints. Areas corresponding to the beam footprints in the second state do not provide traffic for active users, but may provide information required for cell discovery and initial access. Optionally, an NTN service provider (or company) may take into account users (e.g. RACH accesses thereof) entering (or arriving at) the areas corresponding to the beam footprints in the second state, and how they are considered needs to be described in analytical evaluation.

(C) Third state N3: The third state N3 may refer to an ‘active traffic’ state for the beam footprints. The beam footprints (or areas covered by the beam footprints) in the third state N3 may each include X active users (e.g. voice over new radio (VoNR) users). The beam footprints (or areas covered by the beam footprints) in the third state N3 may provide information required for cell discovery and initial access.

As described above, since three states are defined in NTN, to apply a beam hopping method in the NTN system, switching among the three states needs to be performed in a way that does not affect service provision. Additionally, in the second state N2 and the third state N3, where actual satellite beams are activated, a synchronization signal block (SSB) transmission period and an SSB-based measurement timing configuration (SMTC) need to be set based on a dwell time and a revisit time of the beam footprints.

Meanwhile, in order to efficiently apply the beam hopping method to the NTN system, methods considered in network energy saving (NES) techniques may be applied. In NES techniques, cell discontinuous transmission (DTX) and cell discontinuous reception (DRX) mechanisms have been introduced for network energy saving.

According to the cell DTX mechanism, each serving cell may provide a periodic cell DTX pattern configuration to terminals (e.g. user equipments (UEs)) within the cell using RRC signaling. The periodic cell DTX pattern configuration may include information on an active period of the cell and information on a non-active period of the cell. The UE located within the serving cell where the cell DTX is configured does not monitor a physical downlink control channel (PDCCH) and semi-persistent scheduling (SPS) according to the non-active period of the cell.

According to the cell DRX mechanism, each serving cell may provide a periodic cell DRX pattern configuration to UEs within the cell using RRC signaling. The periodic cell DRX pattern configuration may include information on an active period of the cell and information on a non-active period of the cell. The UE located within the serving cell where the cell DRX is configured may not perform transmission on a configured grant (CG) resource, transmission scheduling request (SR) transmission, periodic channel state information (CSI) reporting, semi-persistent CSI reporting, periodic sounding reference signal (SRS) transmission, or semi-persistent SRS transmission according to the non-active period of the cell.

The cell DTX mechanism and cell DRX mechanism in the NES techniques described above may also be applied to an NTN system applying beam hopping. For example, when the cell DTX mechanism and the cell DRX mechanism are applied to the NTN system, a duration during which a beam is activated (illuminated) may be configured according to an active period, and a duration during which a beam is not activated may be configured according to a non-active period. When the cell DTX mechanism and the cell DRX mechanism are applied to an NTN system, the non-active period, in which the beam is not activated, may be understood as a beam hopping DRX pattern. In other words, a time duration in which a satellite transmitting a beam does not steer the beam to a specific beam footprint area based on beam hopping may be understood as a non-active duration according to the beam hopping DRX pattern.

The DRX/DTX configuration for NES may be performed on a cell basis. However, as illustrated in FIG. 1 and FIG. 2, a single satellite may form multiple satellite beam footprints, and one satellite beam footprint may correspond to one cell. As another example, one cell may be configured with one or more satellite beam footprints. In an NTN system in which multiple satellite beams are managed (or controlled) by one satellite (or one cell), it may be difficult to directly apply the DTX/DRX configuration for NES. Therefore, a method is needed to apply the DRX mechanism and/or DTX mechanism in the NTN.

In addition, in an LEO satellite-based NTN, frequent handovers may occur between beams or between satellites due to movements of satellites. In situations where handovers occur due to satellite mobility, application of beam hopping may affect handover performance. Therefore, a method to address this issue is also needed.

In the present disclosure described below, a method for applying the DRX mechanism and/or the DTX mechanism in NTN is described. In addition, in the present disclosure described below, a method for preventing degradation of handover performance due to beam hopping in the LEO satellite-based NTN is described. Furthermore, in the present disclosure described below, a method for minimizing the impact on the current terrestrial network (TN) and NTN technical specifications defined in the 3GPP standard is described.

In the following description, both cases where a base station is not included (or mounted) on a satellite and where a base station is included (or mounted) on a satellite may be applied to the NTN system.

In the case where a base station is not included (or mounted) on a satellite, receiving a signal (or channel or data) from a base station (or network) by a UE may mean that a signal transmitted by the base station located on the ground is transmitted to the satellite through a feeder link, and the satellite transmits the signal to the UE through a service link for providing a specific beam footprint. Therefore, monitoring a signal from the base station by the UE may mean monitoring a service link for providing a specific beam footprint. In addition, in the case where a base station is not included (or mounted) on a satellite, transmitting a signal (or channel or data) to the base station by the UE may mean that the UE transmits a signal to the satellite through a service link for providing a specific footprint, and the satellite transmits the signal to the base station through a feeder link, such that the signal transmitted by the UE is delivered to the base station.

In the case where a base station is included (or mounted) on a satellite, the base station may be included in a satellite communicating with the UE, or may be included in another satellite not communicating with the UE.

First, when the base station is included in the satellite communicating with the UE, receiving a signal (or channel or data) from the base station (or network) by the UE may mean that the satellite transmits a signal to the UE through a service link for providing a specific beam footprint. This may also be similarly understood in the case where the UE monitors a signal (or channel or data) from the base station as described above. In addition, when the base station is included in the satellite communicating with the UE, transmitting a signal (or channel or data) to the base station by the UE may mean that the UE transmits a signal to the satellite through a beam forming a specific footprint.

Next, when the base station is included in another satellite not communicating with the UE, receiving a signal (or channel or data) from the base station (or network) by the UE may mean that a signal is transmitted from another satellite including the base station to a satellite communicating with the UE through an inter-satellite link, and the satellite communicating with the UE transmits the signal to the UE through a service link for providing a specific beam footprint. This may also be similarly understood in the case where the UE monitors a signal (or channel or data) from the base station as described above. In addition, when the base station is included in another satellite not communicating with the UE, transmitting a signal (or channel or data) to the base station by the UE may mean that the UE transmits a signal to the satellite through a beam forming a specific footprint, and the satellite communicating with the UE transmits the signal to another satellite including the base station through an inter-satellite link.

Hereinafter, exemplary embodiments according to the present disclosure are described. The exemplary embodiments of the present disclosure may perform transmission/reception and monitoring of signals between a UE and a base station, as described above.

Various exemplary embodiments according to the present disclosure are described below. In the exemplary embodiments described in the present disclosure, a beam formed by a satellite may provide a service area referred to as a beam footprint. Therefore, although ‘beam’ is described in the following descriptions of the present disclosure, when referring to a service area defined by the beam, ‘beam’ may be understood as ‘beam footprint’. Conversely, although ‘beam footprint’ is described in the following descriptions of the present disclosure, when referring to a specific beam, ‘beam footprint’ may be understood as ‘beam’.

### First Exemplary Embodiment: Method of Transition Between First State N1 and Third State N3

Before describing the first exemplary embodiment of the present disclosure, it should be noted that procedures according to the present disclosure may be performed at a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include a device for acquiring location information of the UE through a satellite navigation system (e.g. global navigation satellite system (GNSS)), if necessary.

The base station and/or satellite may include all or part of the components described in FIG. 3 above. The base station and/or satellite according to the present disclosure may further include additional components other than the components described in FIG. 3 above.

For example, the base station may further include one or more of an interface for connection to the core network, an interface for connection to another base station, an interface for connection to the gateway, and/or an interface for connection to the satellite. In addition, the satellite may further include an inter-satellite communication device (or inter-satellite communication interface) for inter-satellite communication, a communication device (or communication interface with the gateway) for communication between the satellite and the gateway, and/or a communication device (or communication interface with the base station) for communication with the base station.

The first exemplary embodiment of the present disclosure describes an operation of the UE in accordance with a transition from the first state N1 to the third state N3 (i.e. N1→N3), or from the third state N3 to the first state N1 (i.e. N3→N1). As described above, the first state N1 may be a state in which the satellite beam footprints are in the ‘off’ state, and the third state N3 may be a state in which the satellite beam footprints are in the ‘active traffic’ state.

In the first exemplary embodiment, the first state N1 may correspond to an non-active duration of DTX and DRX. The non-active duration of DTX and DRX, which corresponds to the first state N1, is referred to as a ‘first non-active duration’ for distinction from other non-active durations described below. In the first exemplary embodiment, the third state N3 may correspond to an active duration of DTX and DRX. The active duration of DTX and DRX, which corresponds to the third state N3, is referred to as a ‘first active duration’ for distinction from other active durations described below.

The base station may configure first pattern(s) for a state transition from the first non-active duration corresponding to the first state N1 to the first active duration corresponding to the third state N3 for each beam footprint that can be formed by the satellite. Here, the first pattern(s) may include information such as time(s) and/or a period for transitioning from the first non-active duration to the first active duration. For example, the first pattern(s) may include one or more times for transitioning from the first non-active duration to the first active duration. In addition, the period may be information on a time duration during which the first active duration is maintained. As another example, the first pattern(s) may include information on a period for transitioning from the first non-active duration to the first active duration based on a specific reference time. Here, the specific reference time may be provided as information on a single time. The base station may configure only one first pattern corresponding to one beam footprint, or may configure two or more first patterns corresponding to one beam footprint. The base station may transmit a message including information on the first pattern(s) to the UE.

Additionally, the base station may determine second pattern(s) for a state transition from the first active duration corresponding to the third state N3 to the first non-active duration corresponding to the first state N1 for each beam footprint that can be formed by the satellite. Here, the second pattern may include information such as time(s) and/or a period for transitioning from the first active duration to the first non-active duration. For example, the second pattern(s) may include one or more times for transitioning from the first active duration to the first non-active duration. In addition, the period may be information on a time duration during which the first non-active duration is maintained. The base station may configure only one second pattern corresponding to one beam footprint, or may configure two or more second patterns corresponding to one beam footprint. The base station may transmit a message including information on the second pattern(s) to the UE.

The message including information on the first pattern(s) and information on the second pattern(s) may be, for example, an RRC signaling message. The RRC signaling message may be, for example, an RRC configuration message or an RRC reconfiguration message. In the present disclosure described below, for convenience of description, the RRC configuration message and/or the RRC reconfiguration message are collectively referred to as an RRC signaling message. Also, the information on the first pattern(s) and the information on the second pattern(s) may be configured as a pair. For example, information having a value A1 for a first pattern and information having a value B1 for a second pattern may be configured as a pair. When there are multiple second patterns for a first pattern for one beam footprint and/or the one beam footprint corresponding to the first pattern, the RRC signaling message may include information on a plurality of pairs, each composed of a first pattern and a second pattern.

In the above description, a case is assumed in which the information on the first pattern(s) and the information on the second pattern(s) are configured as a pair. However, the information on the first pattern(s) and the information on the second pattern(s) may be configured separately. The information on the first pattern(s) and the information on the second pattern(s), each configured separately, may be included in the RRC signaling message.

In addition, in the above description, a case is assumed in which the information on the first pattern(s) and the information on the second pattern(s) are configured as a pair or separately for each beam footprint that can be formed by the satellite. However, the base station may configure one or more beam footprints among a plurality of beam footprints that can be formed by the satellite into a group, and may determine information on first pattern(s) and information on second pattern(s) for each group composed of one or more beam footprints. In the description below, a group composed of one or more beam footprints among the plurality of beam footprints that can be formed by the satellite is referred to as a ‘beam footprint group’. When information on first pattern(s) and information on second pattern(s) are determined for each beam footprint group, the base station may configure one or more pairs, each composed of information on first pattern(s) and information on second pattern(s), or may configure information on first pattern(s) and information on second pattern(s) separately.

Hereinafter, a case is described in which information on first pattern(s) and information on second pattern(s) are applied in a cell DTX scheme according to the first exemplary embodiment of the present disclosure.

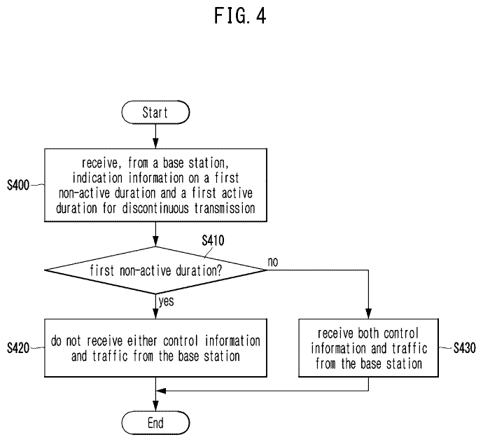

FIG. 4 is a flowchart illustrating a UE-side operation in the cell DTX scheme, according to the first exemplary embodiment of the present disclosure.

In step S400, the UE may, from the base station, receive information indicating a cell DTX (i.e. cell DTX indication information) and information indicating a transition between the first non-active duration and the first active duration. The cell DTX indication information may be information indicating whether a cell DTX is applied to a beam footprint (or beam) formed by the satellite. In the present disclosure, the beam footprint may refer to an area defined by a specific beam. When a cell DTX is applied, the UE may determine that the information indicating the transition between the first non-active duration and the first active duration is valid. If the cell DTX indication information indicates that a cell DTX is not applied, the UE may ignore the information indicating the transition between the first non-active duration and the first active duration. In the description of FIG. 4, it is assumed that the cell DTX indication information indicates that a cell DTX is applied.

The first non-active duration may correspond to a case in which the beam footprint formed by the satellite is in the first state N1, and the first active duration may correspond to a case in which the beam footprint formed by the satellite is in the third state N3, as described above. Therefore, the information indicating the transition between the first non-active duration and the first active duration may be the information on the first pattern(s) and the information on the second pattern(s) described above, or may be information on a pair composed of a first pattern and a second pattern.

The cell DTX indication information may be transmitted by being configured in an RRC signaling message, which is a higher-layer signaling message. The information indicating the transition between the first non-active duration and the first active duration may be indicated to the UE based on one of the following methods.

First, the base station may indicate information on the first pattern for the transition from the first non-active duration to the first active duration and information on the second pattern for the transition from the first active duration to the first non-active duration for one or more beam footprints through a higher-layer signaling message (e.g. RRC signaling message). Accordingly, the UE may receive the higher-layer signaling message and decode the received higher-layer signaling message to acquire the information on the first pattern and the information on the second pattern. In this case, when the cell DTX indication information included in the higher-layer signaling message indicates a cell DTX, the UE may store the acquired information on the first pattern and information on the second pattern.

Second, the base station may transmit, to the UE, a higher-layer signaling message (e.g. RRC signaling message) in which first patterns and second patterns configurable for a specific beam footprint (or beam footprint group) are respectively configured. Accordingly, the UE may receive the first patterns and second patterns for the specific beam footprint (or beam footprint group) from the base station through the higher-layer signaling message. In this case, when the cell DTX indication information included in the higher-layer signaling message indicates a cell DTX, the UE may store the received first patterns and second patterns. Then, the base station may indicate, through a second message (e.g. MAC CE), information indicating one pattern among the first patterns and one pattern among the second patterns, which are configured by the higher-layer signaling message. Accordingly, the UE may identify the first pattern and second pattern to be applied to the current beam footprint (or beam footprint group) through the MAC-CE.

Although the second method has been described using an example in which the higher-layer signaling message is composed of the first patterns and the second patterns, the higher-layer signaling message may be composed of information on a plurality of pairs each comprising a first pattern and a second pattern, as described above. When the higher-layer signaling message is composed of information on a plurality of pairs each comprising a first pattern and a second pattern, the base station may indicate a specific pair through the MAC-CE.

The two examples described above may be applied according to the respective cases as follows. When the non-active duration and the active duration of the beam footprint are statically configured, the first method may be used. On the other hand, when the non-active duration and the active duration of the beam footprint are dynamically configured, the second method may be used.

In step S410, since the cell DTX is indicated, the UE may identify whether the current time is within the first non-active duration based on the first pattern information and the second pattern information. When the current time is within the first non-active duration, the UE may perform step S420, and when the current time is not within the first non-active duration, in other words, when the current time is within the first active duration, the UE may perform step S430.

In step S420, since the base station performs cell DTX and the current time is within the first non-active duration, the UE may not receive either control information or traffic from the base station. For example, the control information may include a system information block (SIB), a synchronization signal block (SSB), a paging signal, and semi-persistent scheduling (SPS). The traffic may include a physical downlink control channel (PDCCH) containing decoding and resource allocation information for data transmitted to the UE, and a physical downlink shared channel (PDSCH) through which traffic data is transmitted. That the control information is not received in the first non-active duration may mean that monitoring of the control information is not performed. Also, that the traffic is not received in the first non-active duration may mean that PDCCH monitoring is not performed.

In step S430, since the current time is within the first active duration, the UE may receive both control information and traffic from the base station. As described in step S420, the control information may include SIB, SSB, a paging signal, and SPS, and the traffic may include a PDCCH and PDSCH transmitted to the UE.

The UE-side operation during cell DTX as described above may be summarized as follows.

First, since the base station performs the cell DTX in the first active duration for one or more beam footprints of the satellite, the UE may monitor SIB, SSB, a paging signal, and SPS as control information during the first active duration and may monitor a PDCCH for user traffic reception and receive a PDSCH based on the PDCCH.

Second, since the base station performs the cell DTX in the first non-active duration for one or more beam footprints of the satellite, the UE may not monitor SIB, SSB, a paging signal, and SPS as control information, and may not monitor a PDCCH for user traffic reception or receive a PDSCH. In other words, during the first non-active duration, the UE may turn off power to a reception-related module for the base station or may operate in a power-saving mode.

Hereinafter, a case is described in which information on the first pattern(s) and information on the second pattern(s) are applied in the cell DRX scheme according to the first exemplary embodiment of the present disclosure.

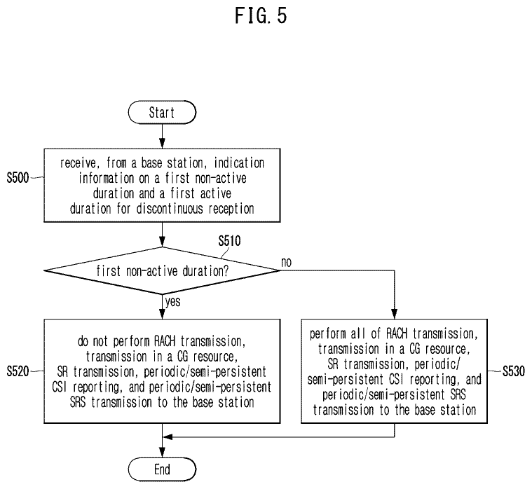

FIG. 5 is a flowchart illustrating a UE-side operation in the cell DRX scheme, according to the first exemplary embodiment of the present disclosure.

In step S500, the UE may receive, from the base station, information indicating a cell DRX (i.e. cell DRX indication information) and information indicating a transition between the first non-active duration and the first active duration. The cell DRX indication information may refer to information indicating whether a cell DRX is applied to a beam footprint formed by a satellite. When a cell DRX is applied, the UE may determine that the indication information on the transition between the first non-active duration and the first active duration is valid. If the cell DRX indication information indicates that a cell DRX is not applied, the UE may ignore the indication information on the transition between the first non-active duration and the first active duration. In the description of FIG. 5, it is assumed that the cell DRX indication information indicates that a cell DRX is applied.

The first non-active duration may correspond to a case in which the beam footprint formed by the satellite is in the first state N1, and the first active duration may correspond to a case in which the beam footprint formed by the satellite is in the third state N3, as described above. Therefore, the indication information on the transition between the first non-active duration and the first active duration may be information on first pattern(s) and information on second pattern(s), or may be information on pair(s) each comprising a first pattern and a second pattern, as described above.

The cell DRX indication information may be transmitted by being configured in an RRC signaling message, which is a higher-layer signaling message. The indication information on the transition between the first non-active duration and the first active duration may be indicated to the UE based on one of the following methods.

First, the base station may indicate information on the first pattern for the transition from the first non-active duration to the first active duration and information on the second pattern for the transition from the first active duration to the first non-active duration for one or more beam footprints through a higher-layer signaling message (e.g. RRC signaling message). Accordingly, the UE may receive the higher-layer signaling message and decode the received higher-layer signaling message to acquire the information on the first pattern and the information on the second pattern. In this case, when the cell DRX indication information included in the higher-layer signaling message indicates a cell DRX, the UE may store the acquired information on the first pattern and information on the second pattern.

Second, the base station may transmit, to the UE, a higher-layer signaling message (e.g. RRC signaling message) in which first patterns and second patterns configurable for a specific beam footprint (or beam footprint group) are configured separately. Accordingly, the UE may receive the first patterns and second patterns for the specific beam footprint (or beam footprint group) from the base station through the higher-layer signaling message. In this case, when the cell DRX indication information included in the higher-layer signaling message indicates a cell DRX, the UE may store the received first patterns and second patterns. Then, the base station may indicate, through a second message (e.g. MAC-CE), indication information on one pattern among the first patterns and one pattern among the second patterns, which are configured by the higher-layer signaling message. Accordingly, the UE may identify the first pattern and second pattern to be applied to the current beam footprint (or beam footprint group) through the MAC-CE.

Although the second method has been described using an example in which the higher-layer signaling message is composed of the first patterns and the second patterns, the higher-layer signaling message may be composed of information on a plurality of pairs each comprising a first pattern and a second pattern, as described above. When the higher-layer signaling message is composed of information on a plurality of pairs each comprising a first pattern and a second pattern, the base station may indicate a specific pair through a MAC-CE.

The two examples described above may be applied according to the respective cases as follows. When the non-active duration and the active duration of the beam footprint are statically configured, the first method may be used. On the other hand, when the non-active duration and the active duration of the beam footprint are dynamically configured, the second method may be used.

In step S510, since the cell DRX is indicated, the UE may identify whether the current time is within the first non-active duration based on the first pattern information and the second pattern information. When the current time is within the first non-active duration, the UE may perform step S520, and when the current time is not within the first non-active duration, the UE may perform step S530.

In step S520, since the base station performs the cell DRX in the first non-active duration, the UE may not transmit either control information or traffic to the base station. The control information transmitted to the base station may include, for example, SR, periodic CSI report, semi-persistent CSI report, periodic SRS, and semi-persistent SRS. Therefore, in step S520, the UE may not perform an initial access procedure through a random access channel (RACH), transmission on a CG resource, SR transmission, periodic CSI reporting, semi-persistent CSI reporting, periodic SRS transmission, or semi-persistent SRS transmission.

In step S530, since the current time is within the first active duration, the UE may transmit all information to the base station. For example, in step S530, the UE may perform an initial access procedure through a RACH, transmission in a CG resource, SR transmission, periodic CSI reporting, semi-persistent CSI reporting, periodic SRS transmission, and semi-persistent SRS transmission.

The UE-side operation during cell DRX as described above may be summarized as follows.

First, in a case where the base station performs cell DRX in the first active duration for one or more beam footprints of the satellite, the UE may monitor SIB, SSB, a paging signal, and SPS as control information during the first active duration and may monitor a PDCCH for user traffic reception and receive a PDSCH based on the PDCCH.

Second, in a case where the base station performs cell DRX during the first non-active duration for one or more beam footprints of the satellite, the UE may be controlled not to perform an initial access procedure through a RACH, transmission in a CG resource, SR transmission, periodic CSI reporting, semi-persistent CSI reporting, periodic SRS transmission, and semi-persistent SRS transmission. In other words, during the first DTX non-active duration, the UE may turn off power to a transmission-related module for the base station or may operate in a power-saving mode.

In the description of the above-described exemplary embodiment, DTX and DRX cases have been described using separate flowcharts. However, DTX and DRX may be configured simultaneously. In this case, when DTX and DRX are configured simultaneously, FIG. 4 and FIG. 5 described above may be combined, and the UE may operate in response to the DTX and DRX configured by the base station.

### Second Exemplary Embodiment: Method of Transition Between Second State N2 and Third State N3

Before describing the second exemplary embodiment of the present disclosure, it should be noted that procedures according to the present disclosure may be performed at a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, mobility speed sensor, etc.). The UE may also include a device for acquiring location information of the UE through a satellite navigation system (e.g. GNSS), if necessary.

The base station and/or satellite may include all or part of the components described in FIG. 3 above. The base station and/or satellite according to the present disclosure may further include additional components other than the components described in FIG. 3 above.

For example, the base station may further include one or more of an interface for connection to the core network, an interface for connection to another base station, an interface for connection to the gateway, and/or an interface for connection to the satellite. In addition, the satellite may further include, for example, an inter-satellite communication device (or inter-satellite communication interface) for inter-satellite communication, a communication device (or gateway communication interface) for communication between the satellite and the gateway, and/or a communication device (or base station communication interface) for communication with the base station.

The second exemplary embodiment of the present disclosure describes operations of the UE in accordance with a transition from the second state N2 to the third state N3 (N2→N3) or from the third state to the second state (N3→N2). As described above, the second state N2 may be the ‘common message only’ state of satellite beam footprints, and the third state N3 may be the ‘active traffic’ state of satellite beam footprints.

In the second exemplary embodiment, the second state N2 may correspond to a non-active duration of DTX and DRX. The non-active duration of DTX and DRX in the second state N2 may be referred to as a ‘second non-active duration’ for distinction from other non-active durations described below. In the second exemplary embodiment, the third state N3 may represent an active duration of DTX and DRX. The active duration of DTX and DRX in the third state N3 may be referred to as a ‘first active duration’ for distinction from other active durations described below.

The base station may configure third pattern(s) for a transition from the second non-active duration corresponding to the second state N2 to the first active duration corresponding to the third state N3 for each beam footprint that can be formed by the satellite. The third pattern(s) may include information such as time(s) and/or a period for transitioning from the second non-active duration to the first active duration. For example, the third pattern(s) may include one or more times for transitioning from the second non-active duration to the first active duration. In addition, the period may be information on a time duration during which the first active duration is maintained. The base station may configure only one third pattern corresponding to one beam footprint, or may configure two or more third patterns corresponding to one beam footprint. The base station may transmit a message including information on the third pattern(s) to the UE. In addition, the base station may determine fourth pattern(s) for a transition from the first active duration corresponding to the third state N3 to the second non-active duration corresponding to the second state N2 for each beam footprint that can be formed by the satellite. The fourth pattern(s) may include information such as time(s) and/or a period for transitioning from the first active duration to the second non-active duration. For example, the fourth pattern(s) may include one or more times for transitioning from the first active duration to the second non-active duration. In addition, the period may be information on a time duration during which the second non-active duration is maintained. The base station may configure only one fourth pattern corresponding to one beam footprint, or may configure two or more fourth patterns corresponding to one beam footprint. The base station may transmit a message including information on the fourth pattern(s) to the UE.

The message including information on the third pattern(s) and information on the fourth pattern(s) may be, for example, an RRC signaling message. The information on the third pattern(s) and the information on the fourth pattern(s) may be configured as a pair. For example, information having a value A2 for a third pattern and information having a value B2 for a fourth pattern may be configured as a pair. When there are multiple fourth patterns for a third pattern for one beam footprint and/or the one beam footprint corresponding to the third pattern, the RRC signaling message may include information on a plurality of pairs, each composed of a third pattern and a fourth pattern. The RRC signaling message may be, for example, an RRC configuration message or an RRC reconfiguration message. In the present disclosure described below, for convenience of description, the RRC configuration message and/or the RRC reconfiguration message are collectively referred to as the RRC signaling message.

In the above description, a case is assumed in which the information on the third pattern(s) and the information on the fourth pattern(s) are configured as a pair. However, the information on third pattern(s) and the information on the fourth pattern(s) may be configured separately. Separately configured information on the third pattern(s) and on the fourth pattern(s) may be included in the RRC signaling message.

In addition, in the above description, a case is assumed in which information on the third pattern(s) and information on the fourth pattern(s) are configured as a pair or separately for each footprint that can be formed by the satellite. However, the base station may configure one or more beam footprints among a plurality of beam footprints that can be formed by the satellite into a group, and may determine third pattern(s) and fourth pattern(s) for each group composed of one or more beam footprints. In the following description, a group composed of one or more beam footprints among the plurality of beam footprints that can be formed by the satellite is referred to as a ‘beam footprint group’. When the third pattern(s) and the fourth pattern(s) are determined for each beam footprint group, the base station may configure the third pattern(s) and the fourth pattern(s) as one or more pairs, or may configure the third pattern(s) and the fourth pattern(s) separately.

Hereinafter, a case is described in which third pattern(s) and fourth pattern(s) are applied in the cell DTX scheme according to the second exemplary embodiment of the present disclosure.

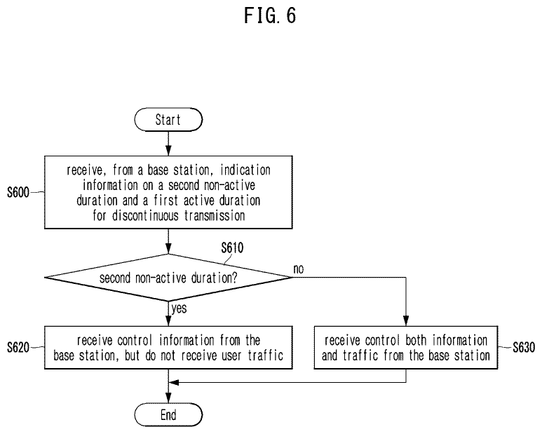

FIG. 6 is a flowchart illustrating a UE-side operation in the cell DTX scheme, according to the second exemplary embodiment of the present disclosure.

In step S600, the UE may receive, from the base station, information indicating a cell DTX (i.e. cell DTX indication information) and information indicating a transition between the second non-active duration and the first active duration. The cell DTX indication information may refer to information indicating whether a cell DTX is applied to a beam footprint formed by a satellite. When a cell DTX is applied, the UE may determine that the indication information on the transition between the second non-active duration and the first active duration is valid. When the cell DTX indication information indicates that a cell DTX is not applied, the UE may ignore the indication information on the transition between the second non-active duration and the first active duration. In the description of FIG. 6, it is assumed that the cell DTX indication information indicates that a cell DTX is applied.

The second non-active duration may correspond to a case in which the beam footprint formed by the satellite is in the second state N2, and the first active duration may correspond to a case in which the beam footprint formed by the satellite is in the third state N3, as described above. Therefore, the indication information on the transition between the second non-active duration and the first active duration may be information on the third pattern(s) and information on the fourth pattern(s), or may be information on pair(s) each comprising a third pattern and a fourth pattern, as described above.

The cell DTX indication information may be transmitted by being configured in an RRC signaling message, which is a higher-layer signaling message. The indication information on the transition between the second non-active duration and the first active duration may be indicated to the UE based on one of the following methods.

First, the base station may indicate, through a higher-layer signaling message (e.g. RRC signaling message), information on a third pattern for a transition from the second non-active duration to the first active duration and information on a fourth pattern for a transition from the first active duration to the second non-active duration, for one or more beam footprints. Accordingly, the UE may receive the higher-layer signaling message and decode the received higher-layer signaling message to acquire the information on the third pattern and information on the fourth pattern. In this case, when the cell DTX indication information included in the higher-layer signaling message indicates a cell DTX, the UE may store the acquired third pattern information and fourth pattern information.

Second, the base station may transmit, to the UE, a higher-layer signaling message (e.g. RRC signaling message) in which third patterns and fourth patterns configurable for a specific beam footprint (or beam footprint group) are configured separately. Accordingly, the UE may receive the third patterns and fourth patterns for the specific beam footprint (or beam footprint group) from the base station through the higher-layer signaling message. In this case, when the cell DTX indication information included in the higher-layer signaling message indicates a cell DTX, the UE may store the third patterns and fourth patterns received through the higher-layer signaling message. Then, the base station may indicate, through a second message (e.g. MAC-CE), indication information indicating one pattern among the third patterns and one pattern among the fourth patterns, which are configured in the higher-layer signaling message. Accordingly, the UE may identify, through the MAC-CE, the third pattern and the fourth pattern to be applied to the current beam footprint (or beam footprint group).

Although the second method has been described with an example in which the higher-layer signaling message includes the third patterns and the fourth patterns separately, the higher-layer signaling message may also be composed of information on a plurality of pairs each comprising a third pattern and a fourth pattern, as described above. When the higher-layer signaling message is composed of information on a plurality of pairs each comprising a third pattern and a fourth pattern, the base station may indicate a specific pair through a MAC-CE.

The two examples described above may be applied according to the respective case as follows. When the non-active duration and the active duration of the beam footprint are statically configured, the first method may be used. On the other hand, when the non-active duration and the active duration of the beam footprint are dynamically configured, the second method may be used.

In step S610, since a cell DTX is indicated, the UE may identify whether the current time is within the second non-active duration based on the third pattern information and the fourth pattern information. When the current time is within the second non-active duration, the UE may perform step S620, and when the current time is not within the second non-active duration, in other words, when the current time is within the first active duration, the UE may perform step S630.

In step S620, since the base station performs a cell DTX and the current time is within the second non-active duration, the UE may not receive user traffic from the base station. In other words, the UE may not monitor a PDCCH and may not receive user traffic through a PDSCH. Since the second non-active duration in step S620 corresponds to the second state N2, that is, the common message only state, the UE may monitor control information other than user traffic. Therefore, in step S620, the UE may monitor control information such as SIB, SSB, paging signal, and SPS.

In step S630, since the base station performs a cell DTX and the current time is within the first active duration, the UE may receive both control information and traffic from the base station. As described in the description of step S620, the control information may include SIB, SSB, paging signal, and SPS, and the traffic may include a PDCCH and PDSCH transmitted to the UE.

The UE-side operation during cell DTX as described above may be summarized as follows.

First, in a case where the base station performs a cell DTX in the first active duration for one or more beam footprints of the satellite, the UE may monitor SIB, SSB, paging signal, and SPS as control information during the first active duration and may monitor a PDCCH for user traffic reception and receive a PDSCH based on the PDCCH.

Second, in a case where the base station performs a cell DTX in the second non-active duration for one or more beam footprints of the satellite, the UE may monitor control information such as SIB, SSB, paging signal, and SPS, but may not monitor a PDCCH for user traffic reception and may not receive a PDSCH. In other words, during the second DTX non-active duration, the UE may perform monitoring only for control information from the base station. Monitoring of control information may be performed only when control information is required or at a time defined by the RRC signaling message.

Hereinafter, a case is described in which the third pattern(s) and fourth pattern(s) are applied in the cell DRX scheme according to the second exemplary embodiment of the present disclosure.

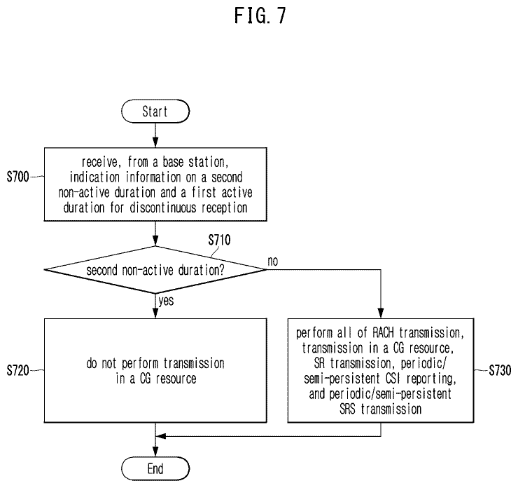

FIG. 7 is a flowchart illustrating a UE-side operation in the cell DRX scheme, according to the second exemplary embodiment of the present disclosure.

In step S700, the UE may receive, from the base station, information indicating a cell DRX (i.e. cell DRX indication information) and information indicating a transition between the second non-active duration and the first active duration. The cell DRX indication information may refer to information indicating whether a cell DRX is applied to a beam footprint formed by a satellite. When a cell DRX is applied, the UE may determine that the indication information on the transition between the second non-active duration and the first active duration is valid. If the cell DRX indication information indicates that a cell DRX is not applied, the UE may ignore the indication information on the transition between the second non-active duration and the first active duration. In the description of FIG. 7, it is assumed that the cell DRX indication information indicates that a cell DRX is applied.

The second non-active duration may correspond to a case in which the beam footprint formed by the satellite is in the second state N2, and the first active duration may correspond to a case in which the beam footprint formed by the satellite is in the third state N3, as described above. Therefore, the indication information on the transition between the second non-active duration and the first active duration may be information on third pattern(s) and information on fourth pattern(s), or may be information on pair(s) each comprising a third pattern and a fourth pattern, as described above.

The cell DRX indication information may be transmitted by being configured in an RRC signaling message, which is a higher-layer signaling message. The indication information on the transition between the second non-active duration and the first active duration may be indicated to the UE based on one of the following methods.

First, the base station may indicate, through a higher-layer signaling message (e.g. RRC signaling message), information on a third pattern for a transition from the second non-active duration to the first active duration and information on a fourth pattern for a transition from the first active duration to the second non-active duration, for one or more beam footprints. Accordingly, the UE may receive the higher-layer signaling message and decode the received higher-layer signaling message to acquire the third pattern information and the fourth pattern information. In this case, when the cell DRX indication information included in the higher-layer signaling message indicates a cell DRX, the UE may store the acquired third pattern information and fourth pattern information.

Second, the base station may transmit, to the UE, a higher layer signaling message (e.g. RRC signaling message) that separately includes third patterns and fourth patterns configurable for a specific beam footprint (or beam footprint group). Therefore, the UE may receive the third patterns and the fourth patterns for the specific beam footprint (or beam footprint group) from the base station through the higher layer signaling message. In this case, when cell DRX indication information included in the higher layer signaling message indicates a cell DRX, the UE may store the third patterns and fourth patterns received through the higher layer signaling message. Further, the base station may indicate, through a second message (e.g. MAC-CE), one pattern among the third patterns and one pattern among the fourth patterns, which are configured in the higher layer signaling message. Therefore, the UE may identify the third pattern and the fourth pattern to be applied to the current beam footprint (or beam footprint group) through the MAC-CE.

Although, in the description of the second method, the case where the higher layer signaling message separately includes the third patterns and the fourth patterns has been described as an example, the higher layer signaling message may also be configured with information on a plurality of pairs each comprising a third pattern and a fourth pattern, as described above. When the higher layer signaling message is configured with information on a plurality of pairs each comprising a third pattern and a fourth pattern, the base station may indicate a specific pair through a MAC-CE.

The two examples described above may be applied depending on the respective cases as follows. When a non-active duration and an active duration of the beam footprint are statically configured, the first method may be used. On the other hand, when the non-active duration and the active duration of the beam footprint are dynamically configured, the second method may be used.

In step S710, since a cell DRX is indicated to the UE, the UE may identify whether the current time is within the second non-active duration based on the third pattern information and the fourth pattern information. When the current time is within the second non-active duration, the UE may perform step S720, and when the current time is not within the second non-active duration, that is, when the current time is within the first active duration, the UE may perform step S730.

In step S720, since the base station performs a cell DRX in the second non-active duration, the UE may not perform transmission in a CG resource. However, in step S720, the UE may perform an initial access procedure through a RACH, SR transmission, periodic CSI reporting, semi-persistent CSI reporting, periodic SRS transmission, and semi-persistent SRS transmission.

In step S730, since the current time is within the first active duration in which the cell DRX is performed, the UE may receive all information from the base station. For example, in step S730, the UE may perform an initial access procedure through a RACH, transmission in a CG resource duration, SR transmission, periodic CSI reporting, semi-persistent CSI reporting, periodic SRS transmission, and semi-persistent SRS transmission.

The UE-side operation during cell DRX as described above is summarized as follows.

First, when the base station performs a cell DRX in the first active duration for one or more beam footprints of a satellite, the UE may perform an initial access procedure through a RACH, transmission in a CG resource duration, SR transmission, periodic CSI reporting, semi-persistent CSI reporting, periodic SRS transmission, and semi-persistent SRS transmission.

Second, when the base station performs a cell DRX in the second non-active duration for one or more beam footprints of the satellite, the UE may perform an initial access procedure through a RACH, SR transmission, periodic CSI reporting, semi-persistent CSI reporting, periodic SRS transmission, and semi-persistent SRS transmission, but may not perform transmission in a CG resource.

In the above-described exemplary embodiment, DTX and DRX cases have been described using separate flowcharts. However, DTX and DRX may be simultaneously configured. In such case, when DTX and DRX are simultaneously configured, FIG. 6 and FIG. 7 described above may be combined, and the UE may operate in response to the DTX and DRX configured by the base station.

### Third Exemplary Embodiment: Method of Transition Between First State N1 and Second State N2

Before describing the third exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). In addition, the UE may further include a device for identifying location information of the UE through a satellite navigation system (e.g. GNSS), if necessary.

The base station and/or satellite may include all or part of the components described in FIG. 3 above. The base station and/or satellite according to the present disclosure may further include additional components other than the components described in FIG. 3 above.

The base station may further include one or more of an interface for connection with the core network, an interface for connection with another base station, an interface for connection with the gateway, and/or an interface for connection with the satellite. In addition, the satellite may further include a satellite-to-satellite communication device (or satellite-to-satellite communication interface) for inter-satellite communication, a communication device (or gateway communication interface) for communication between the satellite and the gateway, and/or a communication device (or base station communication interface) for communication with the base station.

The third exemplary embodiment of the present disclosure describes operations of the UE in a transition from the first state N1 to the second state N2 (N1→N2) or from the second state to the first state (N2→N1). As described above, the first state may be a state in which beam footprints of the satellite are in the off state, and the second state N2 may be a state in which beam footprints of the satellite are in the common message only state.

In the third exemplary embodiment, the first state N1 may correspond to a non-active duration of DTX and DRX. The non-active duration of DTX and DRX, which is the first state N1, is referred to as a ‘first non-active duration’ as described in the first exemplary embodiment above. In the third exemplary embodiment, the second state N2 may correspond to an active duration of DTX and DRX. The active duration of DTX and DRX, which is the second state N2, is referred to as a ‘second active duration’ in the following description.

The base station may configure fifth pattern(s) for a state transition from the first non-active duration, which corresponds to the first state N1, to the second active duration, which corresponds to the second state N2, for each beam footprint that can be formed by the satellite. Here, the fifth pattern(s) may include information such as time(s) and/or a period for the transition from the first non-active duration to the second active duration. For example, the fifth pattern(s) may include one or more times for the transition from the first non-active duration to the second active duration. In addition, the period may be information on a time duration during which the second active duration is maintained. The base station may configure only one fifth pattern corresponding to one beam footprint or may configure two or more fifth patterns corresponding to one beam footprint. The base station may transmit a message including information on the fifth pattern(s) to the UE.

In addition, the base station may determine sixth pattern(s) for a state transition from the second active duration, which corresponds to the second state N2, to the first non-active duration, which corresponds to the first state N1, for each beam footprint that can be formed by the satellite. Here, the sixth pattern may include information such as time(s) and/or a period for the transition from the second active duration to the first non-active duration. For example, the sixth pattern(s) may include one or more times for the transition from the second active duration to the first non-active duration. In addition, the period may be information on a time duration during which the first non-active duration is maintained.

The base station may configure only one sixth pattern corresponding to one beam footprint or may configure two or more sixth patterns corresponding to one beam footprint. The base station may transmit a message including information on the sixth pattern(s) to the UE.

The message including information on the fifth pattern(s) and information on the sixth pattern(s) may be, for example, an RRC signaling message. The fifth pattern(s) and the sixth pattern(s) may be configured as a pair. For example, information having a value A3 for a fifth pattern and information having a value B3 for a sixth pattern may be configured as one pair. When there are multiple sixth patterns for a fifth pattern for one beam footprint and/or the one beam footprint corresponding to the fifth pattern, the RRC signaling message may include information on a plurality of pairs, each composed of a fifth pattern and a sixth pattern. The RRC signaling message may be, for example, an RRC configuration message or an RRC reconfiguration message. In the present disclosure described below, for convenience of description, the RRC configuration message and/or the RRC reconfiguration message are collectively referred to as the RRC signaling message.

In the above description, the case where information on the fifth pattern(s) and information on the sixth pattern(s) are configured as a pair has been assumed. However, the information on the fifth pattern(s) and the information on the sixth pattern(s) may be configured separately. Separately configured information on the fifth pattern(s) and sixth pattern(s) may be included in the RRC signaling message.

In addition, in the above description, the case has been assumed in which the information on the fifth pattern(s) and the information on the sixth pattern(s) are configured as one pair for each of footprints that can be formed by the satellite, or that the information on the fifth pattern(s) and the information on the sixth pattern(s) are configured separately. However, the base station may configure one or more beam footprints among a plurality of beam footprints that cab be formed by the satellite as one group and may determine the fifth pattern(s) and the sixth pattern(s) for each group consisting of one or more beam footprints. In the following description, a group consisting of one or more beam footprints among a plurality of beam footprints that can be formed by the satellite is referred to as a ‘beam footprint group’. When the fifth pattern(s) and the sixth pattern(s) are determined for each beam footprint group, the base station may configure the fifth pattern(s) and the sixth pattern(s) as one or more pairs or may configure the fifth pattern(s) and the sixth pattern(s) separately.

Hereinafter, a case is described in which the fifth pattern(s) and the sixth pattern(s) are applied in the cell DTX scheme according to the third exemplary embodiment of the present disclosure.

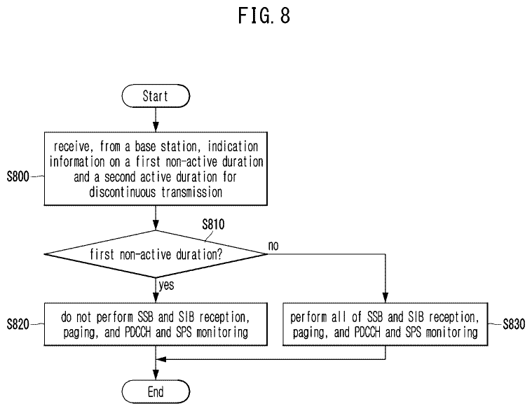

FIG. 8 is a flowchart illustrating a UE-side operation in the cell DTX scheme, according to the third exemplary embodiment of the present disclosure.

In step S800, the UE may receive, from the base station, information indicating a cell DTX (i.e. cell DTX indication information) and information indicating a transition between the first non-active duration and the second active duration. The cell DTX indication information may refer to information indicating whether a cell DTX is applied to a beam footprint formed by the satellite. When a cell DTX is applied, the UE may determine that the indication information on the transition between the first non-active duration and the second active duration is valid. If the cell DTX indication information indicates that a cell DTX is not applied, the UE may ignore the indication information on the transition between the first non-active duration and the second active duration. In the description of FIG. 8, a case where the cell DTX indication information indicates that a cell DTX is applied is assumed.

The first non-active duration may correspond to a case in which the beam footprint formed by the satellite is in the first state N1, as described above, and the second active duration may correspond to a case in which the beam footprint formed by the satellite is in the second state N2, as described above. Therefore, the indication information on the transition between the first non-active duration and the second active duration may be information on fifth pattern(s) and sixth pattern(s) described above or may be information on pair(s) each comprising a fifth pattern and a sixth pattern.

The Cell DTX indication information may be transmitted by being configured in a higher layer signaling message, such as an RRC signaling message. The indication information on the transition between the first non-active duration and the second active duration may be indicated to the UE based on one of the following methods.

First, the base station may indicate, through a higher layer signaling message (e.g. RRC signaling message), information on a fifth pattern for a transition from the first non-active duration to the second active duration and information on a sixth pattern for a transition from the second active duration to the first non-active duration, for one or more beam footprints. Accordingly, the UE may receive the higher layer signaling message and decode the received higher layer signaling message to acquire the fifth pattern information and the sixth pattern information. In this case, when the cell DTX indication information included in the higher layer signaling message indicates a cell DTX, the UE may store the acquired fifth pattern information and sixth pattern information.

Second, the base station may transmit, to the UE, a higher layer signaling message (e.g. RRC signaling message) that separately includes fifth patterns and sixth patterns configurable for a specific beam footprint (or beam footprint group). Accordingly, the UE may receive, from the base station through the higher layer signaling message, the first patterns and the second patterns for the specific beam footprint (or beam footprint group). In this case, when the cell DTX indication information included in the higher layer signaling message indicates a cell DTX, the UE may store the first patterns and the second patterns received through the higher layer signaling message. The base station may indicate, through a second message (e.g. MAC-CE), indication information on one of the first patterns and one of the second patterns configured in the higher layer signaling message. Accordingly, the UE may identify, through the MAC-CE, a first pattern and a second pattern to be applied to the current beam footprint (or beam footprint group).

Although the second method has been described with an example in which the higher layer signaling message separately includes first patterns and second patterns, the higher layer signaling message may be configured with information on a plurality of pairs each comprising a fifth pattern and a sixth pattern, as described above. When the higher layer signaling message is configured with information on a plurality of pairs each comprising a fifth pattern and a sixth pattern, the base station may indicate a specific pair through the MAC-CE.

The two examples described above may be applied according to the respective cases as follows. When inactive and active durations of a beam footprint are configured statically, the first method may be used. On the other hand, when inactive and active durations of a beam footprint are configured dynamically, the second method may be used.

In step S810, since a cell DTX is indicated to the UE, the UE may identify whether the current time is within the first non-active duration based on the fifth pattern information and the sixth pattern information. When the current time is within the first non-active duration, the UE may perform step S820. When the current time is not within the first non-active duration, that is, when the current time is within the second active duration, the UE may perform step S830.

Since step S820 corresponds to a case in which the base station performs cell DTX and the current time is within the first non-active duration, the UE may not perform SSB reception, SIB reception, paging, PDCCH monitoring, and SPS monitoring for the base station. As described above, the first non-active duration may correspond to a case in which the beam footprint formed by the satellite is in the first state N1, and therefore, the corresponding beam footprint formed by the satellite may be in the off state. Thus, the UE may not expect any signal reception from the satellite.

Since step S830 corresponds to a case in which the base station performs cell DTX and the current time is within the second active duration, the UE may perform SSB reception, SIB reception, paging, PDCCH monitoring, and SPS monitoring for the base station in step S830.

The UE-side operation during cell DTX described above is summarized as follows.

First, since the base station performs cell DTX in the second active duration for one or more beam footprints formed by the satellite, the UE may perform SSB reception, SIB reception, paging monitoring, PDCCH monitoring, and SPS monitoring in the second active duration.

Second, since the base station performs cell DTX in the first non-active duration for one or more beam footprints formed by the satellite, the UE may not perform SSB reception, SIB reception, paging, PDCCH monitoring, and SPS monitoring. In other words, during the first non-active duration, the UE may turn off power for a reception-related module for the base station or may operate in a power-saving mode.

Hereinafter, a case is described in which the fifth pattern(s) and sixth pattern(s) are applied in the cell DRX scheme according to the third exemplary embodiment of the present disclosure.

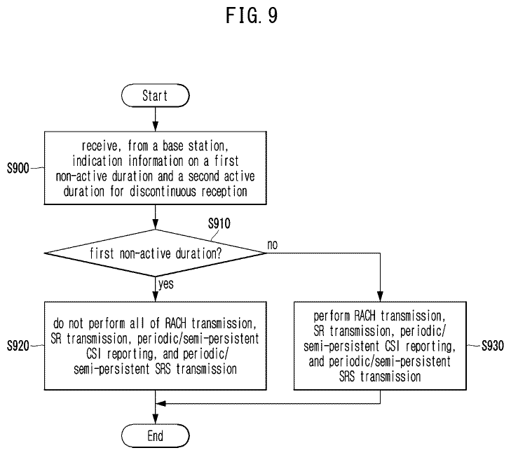

FIG. 9 is a flowchart illustrating a UE-side operation in the cell DRX scheme, according to the third exemplary embodiment of the present disclosure.

In step S900, the UE may receive, from the base station, information indicating a cell DRX (i.e. cell DRX indication information) and information indicating a transition between the first non-active duration and the second active duration. The cell DRX indication information may refer to information indicating whether a cell DRX is applied to a beam footprint formed by the satellite. When a cell DRX is applied, the UE may determine that the indication information on the transition between the first non-active duration and the second active duration is valid. When the cell DRX indication information indicates that a cell DRX is not applied, the UE may ignore the indication information on the transition between the first non-active duration and the second active duration. The following description of FIG. 9 assumes that the cell DRX indication information indicates that a cell DRX is applied.

The first non-active duration may correspond to a case in which the beam footprint formed by the satellite is in the first state N1, as described above, and the second active duration may correspond to a case in which the beam footprint formed by the satellite is in the second state N2, as described above. Accordingly, the indication information on the transition between the first non-active duration and the second active duration may be information on fifth pattern(s) and sixth pattern(s), or may be information on pair(s) each comprising a fifth pattern and a sixth pattern, as described above.

The cell DRX indication information may be transmitted by being configured in a higher layer signaling message, such as an RRC signaling message. The indication information on the transition between the first non-active duration and the second active duration may be indicated to the UE based on one of the following methods.

First, the base station may indicate, through a higher layer signaling message (e.g. RRC signaling message), information on a fifth pattern for the transition from the first non-active duration to the second active duration and information on a sixth pattern for the transition from the second active duration to the first non-active duration, for one or more beam footprints. Accordingly, the UE may receive the higher layer signaling message and decode the received higher layer signaling message to acquire the fifth pattern information and the sixth pattern information. In this case, when the cell DRX indication information included in the higher layer signaling message indicates a cell DRX, the UE may store the acquired fifth pattern information and sixth pattern information.

Second, the base station may transmit, to the UE, a higher layer signaling message (e.g. RRC signaling message) that separately includes fifth patterns and sixth patterns configurable for a specific beam footprint (or beam footprint group). Accordingly, the UE may receive, from the base station through the higher layer signaling message, the fifth patterns and the sixth patterns for the specific beam footprint (or beam footprint group). In this case, when the cell DRX indication information included in the higher layer signaling message indicates a cell DRX, the UE may store the fifth patterns and the sixth patterns received through the higher layer signaling message. The base station may indicate, through a second message (e.g. MAC-CE), indication information indicating one of the fifth patterns and one of the sixth patterns, which are configured in the higher layer signaling message. Accordingly, the UE may identify, through the MAC-CE, the fifth pattern and the sixth pattern to be applied to the current beam footprint (or beam footprint group).

In the description of the second method, an example has been described in which the higher layer signaling message separately includes the fifth patterns and the sixth patterns. However, as described above, the higher layer signaling message may be configured with information on a plurality of pairs each comprising a fifth pattern and a sixth pattern. When the higher layer signaling message is configured with information on a plurality of pairs each comprising a fifth pattern and a sixth pattern, the base station may indicate a specific pair through the MAC-CE.

The two examples described above may be applied according to the respective cases as follows. When inactive and active durations of a beam footprint are configured statically, the first method may be used. On the other hand, when inactive and active durations of a beam footprint are configured dynamically, the second method may be used.

In step S910, since a cell DRX is indicated, the UE may identify whether the current time is within the first non-active duration based on the fifth pattern information and the sixth pattern information. When the current time is within the first non-active duration, the UE may perform step S920. When the current time is not within the first non-active duration, in other words, when the current time is within the second active duration, the UE may perform step S930.

In step S920, since base station performs the cell DRX in the first non-active duration, the UE may not perform RACH transmission, SR transmission, periodic/semi-persistent CSI reporting, or periodic/semi-persistent SRS reporting. Since the first non-active duration corresponds to a state in which the beam footprint formed by the satellite is in the off state, the base station may not receive any information through the corresponding beam. Therefore, the UE may also be prohibited from performing RACH transmission, SR transmission, periodic/semi-persistent CSI reporting, or periodic/semi-persistent SRS reporting.

In step S930, since the current time is within the second active duration and the cell DRX is performed, the UE may perform RACH transmission, SR transmission, periodic/semi-persistent CSI reporting, and periodic/semi-persistent SRS reporting.

The UE-operation during cell DRX described above is summarized as follows.

First, when the base station performs a cell DRX in the second active duration for one or more beam footprints formed by the satellite, the UE may perform RACH transmission, SR transmission, periodic/semi-persistent CSI reporting, and periodic/semi-persistent SRS reporting.

Second, when the base station performs a cell DRX in the first non-active duration for one or more beam footprints formed by the satellite, the UE may not perform, or may be prohibited from performing RACH transmission, SR transmission, periodic/semi-persistent CSI reporting, and periodic/semi-persistent SRS reporting.

In describing the above exemplary embodiments, DTX and DRX cases have been described using separate flowcharts. However, DTX and DRX may be configured simultaneously. In such a case where DTX and DRX are configured simultaneously, FIG. 8 and FIG. 9 described above may be combined, and the UE may operate in response to the DTX and DRX configured by the base station.

Meanwhile, although the first to third exemplary embodiments described above have been described as separate exemplary embodiments, the 3GPP NTN technical specifications define the first state N1, second state N2, and third state N3 for a beam footprint. Therefore, one of the first to third exemplary embodiments may be used in combination with at least one of other exemplary embodiments.

### Fourth Exemplary Embodiment: Method of Transition Between Active and Non-Active Durations of NES

Before describing the fourth exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include, if necessary, a device for acquiring location information of the UE through a satellite navigation system (e.g. GNSS).

The base station and/or the satellite may include all or part of the components described in FIG. 3 above. The base station and/or the satellite according to the present disclosure may further include additional components other than the components described in FIG. 3 above.

The base station may further include at least one of an interface for connection with the core network, an interface for connection with another base station, an interface for connection with the gateway, and/or an interface for connection with the satellite. The satellite may further include, for example, an inter-satellite communication device (or inter-satellite communication interface) for communication between satellites, a communication device between the satellite and the gateway (or a communication interface with the gateway), and/or a communication device for communication with the base station (or a communication interface with the base station).

The fourth exemplary embodiment of the present disclosure may apply the NES-based cell DTX mechanism and the NES-based cell DRX mechanism to each beam footprint or beam footprint group of the satellite. In other words, the NES-based cell DTX mechanism and/or the NES-based cell DRX mechanism may be applied to each of the satellite beam footprints. The base station may configure active durations and non-active durations according to the NES scheme for each satellite beam. Configuring active and non-active durations may refer to configuring a transition pattern from the non-active duration to the active duration and a transition pattern from the active duration to the non-active duration.

For example, the base station may configure a seventh pattern for the transition from the non-active duration to the active duration according to the NES scheme for each satellite beam (or satellite beam group) and transmit a message configured with information on the seventh pattern to the UE. The base station may also configure an eighth pattern for the transition from the active duration to the non-active duration according to the NES scheme for each satellite beam (or satellite beam group) and transmit a message configured with information on the eighth pattern to the UE. The seventh pattern information and the eighth pattern information may be separately configured in a higher layer signaling message (e.g. RRC signaling message), or the seventh pattern information and the eighth pattern information may be configured as a pair within the higher layer signaling message. The RRC signaling message may be, for example, an RRC configuration message or an RRC reconfiguration message. In the present disclosure described below, for convenience of description, the RRC configuration message and/or the RRC reconfiguration message are collectively referred to as the RRC signaling message.

Hereinafter, a case is described in which the seventh pattern and the eighth pattern are applied to the cell DTX scheme according to the fourth exemplary embodiment of the present disclosure.

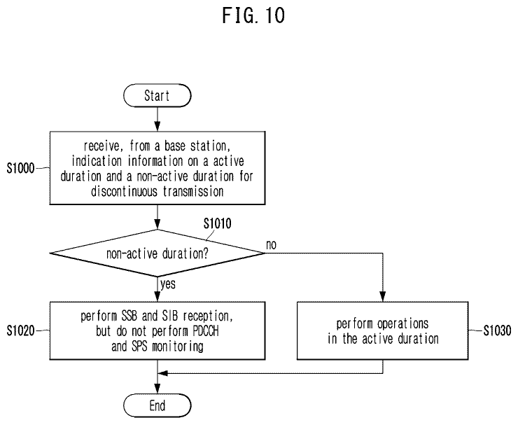

FIG. 10 is a flowchart illustrating a UE-side operation in the cell DTX scheme, according to the fourth exemplary embodiment of the present disclosure.

In step 1000, the UE may receive, from the base station, information indicating a cell DTX (i.e. cell DTX indication information) and information indicating a transition between the non-active duration and the active duration. The cell DTX indication information may refer to information indicating whether a cell DTX is applied to a beam footprint formed by the satellite. In particular, the cell DTX indication information according to the fourth exemplary embodiment may indicate that a cell DTX is in accordance with the NES scheme. When a cell DTX is applied, the UE may determine that the indication information on the transition between the non-active duration and the active duration is valid. When the UE determines that the cell DTX indication information indicates a cell DTX is not applied, the UE may ignore the indication information on the transition between the first non-active duration and the second active duration. In the description of FIG. 10, it is assumed that the cell DTX indication information indicates that a cell DTX is applied.

The indication information on the transition between the non-active duration and the active duration may be the seventh pattern information and the eighth pattern information described above, or may be information of a pair comprising the seventh pattern and the eighth pattern. The cell DTX indication information may be transmitted by being configured in a higher layer signaling message such as an RRC signaling message. The indication information on the transition between the non-active duration and the active duration may also be configured and transmitted in a higher layer signaling message such as an RRC signaling message.

In step 1010, since a cell DTX is indicated, the UE may identify whether the current time is within the non-active duration based on the seventh pattern information and the eighth pattern information. When the current time is within the non-active duration, the UE may perform step 1020, and when the current time is not within the non-active duration, in other words, when the current time is within the active duration, the UE may perform step 1030.

In step 1020, since the base station performs cell DTX and the current time is within the non-active duration according to the NES scheme, the UE may perform SSB reception, SIB reception, and paging monitoring, but may not perform PDCCH reception and SPS monitoring.

In step 1030, since the base station performs cell DTX and the current time is within the active duration, the UE may receive all control information and all traffic from the base station. The control information may include all control information described in the first, second, and third exemplary embodiments above. The traffic may include a PDCCH and PDSCH transmitted to the UE.

Hereinafter, UE-side operations based on the seventh pattern and the eighth pattern are described in a case where the cell DRX in the NES scheme is performed according to the fourth exemplary embodiment of the present disclosure.

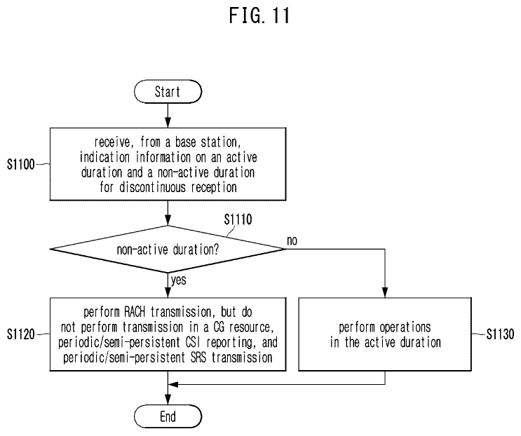

FIG. 11 is a flowchart illustrating a UE-side operation in the cell DRX scheme, according to the fourth exemplary embodiment of the present disclosure.

In step 1100, the UE may receive, from the base station, cell DRX indication information and indication information on a transition between the non-active duration and the active duration. The cell DRX indication information may refer to information indicating whether a cell DRX is applied to a beam footprint formed by the satellite. In particular, the cell DRX indication information according to the fourth exemplary embodiment may indicate that the cell DRX is in accordance with the NES scheme. When the cell DRX is applied, the UE may determine that the indication information on the transition between the non-active duration and the active duration is valid. When the cell DRX indication information indicates that a cell DRX is not applied, the UE may ignore the indication information on the transition between the first non-active duration and the second active duration. In the description of FIG. 11, it is assumed that the cell DRX indication information indicates that a cell DRX is applied.

The indication information on the transition between the non-active duration and the active duration may separately include the seventh pattern information and the eighth pattern information described above, or may include information of a pair comprising the seventh pattern and the eighth pattern. The cell DRX indication information may be configured and transmitted in a higher layer signaling message such as an RRC signaling message. The indication information on the transition between the non-active duration and the active duration may also be configured and transmitted in a higher layer signaling message such as an RRC signaling message.

In step 1110, since the cell DRX is indicated, the UE may identify whether the current time is within the non-active duration based on the seventh pattern information and the eighth pattern information. When the current time is within the non-active duration, the UE may perform step 1120, and when the current time is not within the non-active duration, in other words, when the current time is within the active duration, the UE may perform step 1130.

In step 1120, since the base station performs the cell DRX in the non-active duration, the UE may perform RACH transmission, but may be prohibited from performing transmission in a CG resource, periodic CSI reporting and/or semi-persistent CSI reporting, and periodic SRS transmission and/or semi-persistent SRS transmission.

In step 1130, since the current time is within the active duration and the base station performs the cell DRX, the UE may perform all procedures such as RACH transmission, SR transmission, periodic CSI reporting and/or semi-persistent CSI reporting, and periodic SRS transmission and/or semi-persistent SRS transmission.

### Fourth-1 Exemplary Embodiment: Method for Configuring Information for NES-Based DTX and DRX Operations

In the case of the fourth exemplary embodiment described above, since the DTX/DRX operation of the NES is directly applied, the influence on the current 3GPP 5G NR technical specifications may be minimized. However, in the first state N1 of NTN, a RACH procedure, monitoring of paging, SIB reception, and SSB reception may be impossible. Therefore, in order for the UE to operate in the same manner as in 5G NR, there may be an issue where the network and/or operation procedures need to be designed to avoid being affected by the first state N1 of the NTN.

Before describing the fourth-1 exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include, if necessary, a device for acquiring location information of the UE through a satellite navigation system (e.g. GNSS).

The base station and/or the satellite may include all or part of the components described in FIG. 3 above. The base station and/or the satellite according to the present disclosure may further include additional components other than the components described in FIG. 3 above.

The base station may further include at least one of an interface for connection with the core network, an interface for connection with another base station, an interface for connection with the gateway, and/or an interface for connection with the satellite. The satellite may further include, for example, an inter-satellite communication device (or inter-satellite communication interface), a communication device between the satellite and the gateway (or a communication interface with the gateway), and/or a communication device for communication with the base station (or a communication interface with the base station).

According to the current 3GPP technical specifications, for the NES-based DTX/DRX operations, up to four DTX/DRX operation patterns may be configured on a cell basis. However, in the case of NTN, a single physical satellite beam may be mapped to one cell, or multiple satellite beams may be mapped to a single cell. Therefore, when DTX/DRX operations are performed on a cell basis, there is a problem that satellite characteristics, such as different propagation delays and propagation delay differences per satellite beam, cannot be mapped on a cell basis. Accordingly, there is a problem in that it is very difficult to configure beam-hopping patterns optimized for the respective satellite beams. To address this problem and enable the UE to operate in an active duration and a non-active duration according to the NES scheme, there may be an issue that SSBs and/or SMTC patterns need to be designed not to be affected by UE operations.

In consideration of such issues, the present disclosure defines beam-based DTX/DRX patterns instead of defining cell-based DTX/DRX patterns of NES. The present disclosure also defines, for each beam, a plurality of DTX patterns and/or a plurality of DRX patterns optimized for each of the exemplary embodiments described above. Information on the plurality of DTX patterns and/or the plurality of DRX patterns for each beam may be configured to the UE through higher layer signaling, for example, an RRC signaling message. As another example, the information may be indicated to the UE through a group-common layer 1 (L1) DCI instead of an RRC signaling message. Information included in the RRC signaling message or the group-common L1 DCI may include one or more of the following.

### <Information Included in the RRC Signaling Message or L1 DCI>

Satellite identifier (ID)
Cell identifier (Cell ID) within the satellite
Beam identifier (ID) within the cell
DTX active duration (or DTX non-active duration) per beam and DTX period per beam
DRX active duration (or DRX non-active duration) per beam and DRX period per beam

The DTX and DRX patterns on a beam basis may be independently configured. When multiple satellites or multiple cells are not configured, a satellite identifier and a cell identifier may not be included.

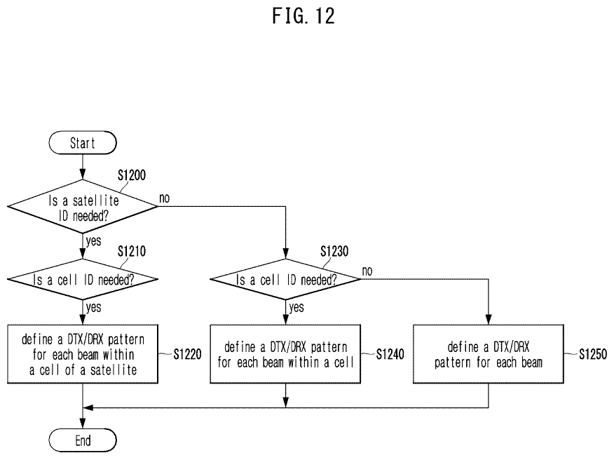

FIG. 12 is a flowchart illustrating a method of configuring information for DTX and DRX operations based on the NES scheme for NTN satellite beams.

In step 1200, the base station may determine whether a satellite identifier (ID) needs to be provided to the UE for DTX and DRX operations according to the NES scheme. The case where the satellite ID is needed for DTX and DRX operations according to the NES scheme may correspond to a case in which multiple satellites and/or multiple cells are configured. When a result of the determination in step 1200 indicates that the satellite ID is needed, the base station may perform step 1210, and when the result indicates that the satellite ID is not needed, the base station may perform step 1230.

In step 1210, the base station may determine whether a cell ID needs to be provided to the UE for DTX and DRX operations according to the NES scheme. When a result of the determination in step 1210 indicates that the cell ID is needed, the base station may define, in step 1220, a beam-specific DTX pattern within the cell of the satellite and a beam-specific DRX pattern within the cell of the satellite. Meanwhile, since the case in which the satellite ID is needed corresponds to a case in which multiple satellites and/or multiple cells are configured as described above, step 1210 may be omitted. The beam-specific DTX pattern within the cell of the satellite and/or the beam-specific DRX pattern within the cell of the satellite, which are defined by the base station in step 1220, may be configured to the UE through an RRC signaling message or transmitted to the UE through an L1 DCI, as described above (not shown in FIG. 12).

When the result of the determination result in step 1200 indicates that the satellite ID is not needed, the base station may perform step 1230. In step 1230, the base station may determine whether the cell ID needs to be provided to the UE. When a result of the determination in step 1230 indicates that the cell ID is needed, the base station may define, in step 1240, a beam-specific DTX pattern within the cell and/or a beam-specific DRX pattern within the cell. The beam-specific DTX pattern and/or the beam-specific DRX pattern within the cell, which are defined by the base station in step 1240, may be configured to the UE through an RRC signaling message or configured to the UE through an L1 DCI (not shown in FIG. 12).

When the result of the determination in step 1230 indicates that the cell ID is not needed, the base station may perform step 1250. In step 1250, the base station may define a beam-specific DTX pattern and/or a beam-specific DRX pattern. The beam-specific DTX pattern and/or the beam-specific DRX pattern defined by the base station in step 1250 may be configured to the UE through an RRC signaling message or configured to the UE through an L1 DCI (not shown in FIG. 12).

### Fourth-2 Exemplary Embodiment: Operation Method of Base Station and UE for DTX and DRX Under NES Application

Before describing the fourth-2 exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include, if necessary, a device for acquiring location information of the UE through a satellite navigation system (e.g. GNSS).

The base station and/or the satellite may include all or part of the components described in FIG. 3 above. The base station and/or the satellite according to the present disclosure may further include additional components other than the components described in FIG. 3 above.

The base station may further include at least one of an interface for connection with the core network, an interface for connection with another base station, an interface for connection with the gateway, and/or an interface for connection with the satellite. The satellite may further include, for example, an inter-satellite communication device (or inter-satellite communication interface), a communication device between the satellite and the gateway (or a communication interface with the gateway), and/or a communication device for communication with the base station (or a communication interface with the base station).

In the NES scheme, a cell coverage controlled by a single base station in a TN may be smaller than a cell coverage controlled by a satellite in an NTN. Therefore, when the NES scheme is applied in the TN, a cell-based common DTX pattern and/or a cell-based common DRX pattern may be applied to all UEs. In other words, when the NES scheme is applied to all UEs within a specific cell in the TN, applying the cell-based common DTX pattern and/or the cell-based common DRX pattern may not pose a problem.

On the other hand, when a beam formed by a satellite or a cell configured by a satellite is used to define a cell-based common DTX pattern and/or a cell-based common DRX pattern in an NTN, propagation delays among UEs within the cell (or beam) or between cells (or beams) may vary, and a difference in propagation delays may vary depending on the UE's location. When the cell-based common DTX pattern and/or the cell-based common DRX pattern is defined by the beam formed by the satellite or the cell configured by the satellite, inefficient operations may occur for a specific UE depending on a location of the UE.

The present disclosure provides methods for solving the above-described problems.

### [First Method]

To solve the above-described problems, the base station may configure a UE-specific DTX pattern and/or a UE-specific DRX pattern for each UE within a beam footprint formed by the satellite or within a cell formed by the satellite, and may transmit the configured UE-specific DTX pattern and/or UE-specific DRX pattern to each UE. In this case, the UE-specific DTX pattern and/or UE-specific DRX pattern may be transmitted through a higher layer signaling message (e.g. RRC signaling message). Accordingly, all UEs within the beam footprint formed by the satellite or within the cell formed by the satellite may receive the UE-specific DTX patterns and/or UE-specific DRX patterns assigned to the respective UEs.

### [Second Method]

In the first method described above, the base station is required to configure a UE-specific DTX pattern and/or a UE-specific DRX pattern for each UE within a beam footprint formed by the satellite or within a cell formed by the satellite, and transmit the configured UE-specific DTX pattern and/or UE-specific DRX pattern to each UE. Therefore, the base station may require a procedure for identifying locations of a large number of UEs, since the base station needs to configure a UE-specific DTX pattern and/or UE-specific DRX pattern for each of the UEs. In addition, since the base station needs to configure a UE-specific DTX pattern and/or UE-specific DRX pattern for each of the UEs, computational complexity of the base station may increase. Furthermore, to transmit the configured UE-specific DTX pattern and/or UE-specific DRX pattern to each of the UEs, a large amount of signaling overhead may occur.

Therefore, in the second method, the base station may transmit a cell-based or beam-based common DTX pattern and/or common DRX pattern to all UEs within the beam footprint formed by the satellite or within the cell formed by the satellite. In other words, a method identical to the one used for applying the NES scheme in a TN may be used. In the second method, operations of the base station and the UE may vary as follows.

A UE located within a beam footprint formed by a satellite or within a cell formed by a satellite may receive a cell-based or beam-based common DTX pattern and/or common DRX pattern from the base station. The base station may transmit satellite assistance information to the UE located within the beam footprint formed by the satellite or within the cell formed by the satellite. The satellite assistance information may be provided in various forms. For example, the satellite assistance information may be provided to the UE in form of system information (SI). As another example, the satellite assistance information may be commonly provided to all UEs through a higher layer signaling message (e.g. RRC signaling message). An initial access location of a UE located within the beam footprint formed by the satellite or within the cell formed by the satellite may be at an edge of the cell (or beam) or at a center of the cell (or beam). Therefore, it may be preferable for the satellite assistance information to be provided to the UE in form of SI.

A UE located within the beam footprint formed by the satellite or within the cell formed by the satellite may receive the satellite assistance information and the cell-based or beam-based common DTX pattern and/or common DRX pattern through the base station. The UE may determine a DTX pattern and/or a DRX pattern specialized for the UE based on the satellite assistance information and the cell-based or beam-based common DTX pattern and/or common DRX pattern. The UE may use the determined specialized DTX pattern and/or DRX pattern.

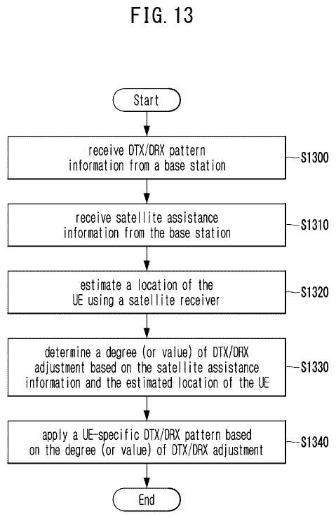

FIG. 13 is a flowchart illustrating a method for DTX and DRX operations of a UE under NES application.

In step 1300, the UE may receive DTX pattern and/or DRX pattern information from the base station. In this case, the DTX pattern and/or DRX pattern information received from the base station may be cell-based (or beam-based) common DTX pattern and/or cell-based (or beam-based) common DRX pattern information, as described above. The UE may store the received DTX pattern and/or DRX pattern information.

In step 1310, the UE may receive satellite assistance information from the base station. In the present disclosure, the satellite assistance information may be received using one of SI or an RRC signaling message, as described above. In the following description, it is assumed that the satellite assistance information is transmitted in form of SI. The satellite assistance information may be information for adjusting the cell-based (or beam-based) common DTX pattern and/or cell-based (or beam-based) common DRX pattern according to a location of the UE, as described above. The satellite assistance information may be included, for example, in SIB19 that contains information for NTN access. As another example, the satellite assistance information may be included in SIB21 that contains information on neighboring cells and/or satellite gateways in the NTN. The UE may receive the satellite assistance information.

In step 1320, the UE may estimate a location of the UE using a satellite receiver. A method of estimating the location of the UE using the satellite receiver may employ one of a GNSS scheme and/or a GPS scheme. There are various widely known methods in which the UE estimates the UE's location based on signals received from a plurality of satellites. Therefore, in the present disclosure, no specific limitation is imposed on the method for estimating the UE's location, and unnecessary descriptions are omitted.

In step 1330, the UE may determine a degree (or value) of adjustment for the cell-based (or beam-based) common DTX pattern and/or cell-based (or beam-based) common DRX pattern based on the satellite assistance information and the estimated location of the UE. The degree (or value) of adjustment for the cell-based (or beam-based) common DTX pattern and/or the cell-based (or beam-based) common DRX pattern may be determined based on how far the UE is separated from a reference point of the beam (or cell) formed by the satellite, and depending on the characteristics of the satellite, the degree (or value) of adjustment for the cell-based (or beam-based) common DTX pattern and/or cell-based (or beam-based) common DRX pattern may be preconfigured in a table. The characteristics of the satellite may vary depending on whether the satellite is a geostationary satellite that is always positioned in a geostationary orbit, a quasi-geostationary satellite, or a moving satellite.

In step 1340, the UE may apply a DTX pattern and/or a DRX pattern suitable for the UE based on the determined degree (or value) of adjustment for the cell-based (or beam-based) common DTX pattern and/or cell-based (or beam-based) common DRX pattern. The application of the DTX pattern and/or DRX pattern suitable for the UE may mean that the operations may be performed according to one of the first through fourth exemplary embodiments described above.

### Fifth Exemplary Embodiment: Beam Hopping Method During DTX and/or DRX Operations in NTN

Before describing the fifth exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include, if necessary, a device for acquiring location information of the UE through a satellite navigation system (e.g. GNSS).

The base station and/or the satellite may include all or part of the components described in FIG. 3 above. The base station and/or the satellite according to the present disclosure may further include additional components other than the components described in FIG. 3 above.

The base station may further include at least one of an interface for connection with the core network, an interface for connection with another base station, an interface for connection with the gateway, and/or an interface for connection with the satellite. The satellite may further include, for example, an inter-satellite communication device (or inter-satellite communication interface), a communication device between the satellite and the gateway (or a communication interface with the gateway), and/or a communication device for communication with the base station (or a communication interface with the base station).

In the following, in an NTN, a beam hopping scheme may be applied in order to allocate satellite resources to areas with high user density. The base station needs to inform the UE of the beam hopping of the satellite so that the UE can perform communication smoothly. Accordingly, the base station may transmit DTX pattern information and/or DRX pattern information of a serving cell (or beam) to the UE. In addition, due to movement of the UE or movement of the satellite, the serving cell (or beam) may change. To address this, the base station may transmit DTX pattern information and/or DRX pattern information of neighboring cells (or beams) to the UE.

By transmitting DTX pattern information and/or DRX pattern information of neighboring cells (or beams) to the UE, the base station may prevent the UE from attempting a handover during the DTX non-active duration and/or DRX non-active duration of a neighboring cell (or beam) when the UE enters the neighboring cell (or beam). In addition, in the case where the satellite is an Earth moving cell, a position of the beam may change due to satellite movement even if the UE remains in a fixed location. Not only due to satellite movement but also due to UE movement, the location of the UE within the cell (or beam) may deviate from a reference location. Therefore, in such cases, by transmitting DTX pattern information and/or DRX pattern information of a neighboring cell (or beam) to the UE, the base station may prevent the UE from attempting a handover during the DTX non-active duration and/or DRX non-active duration of the neighboring cell (or beam) when the UE enters the neighboring cell (or beam).

Meanwhile, as described above in 3GPP, in each of the first state N1, the second state N2, and the third state N3, the size of the beam formed by the satellite may differ. Accordingly, the base station may provide, together with the beam hopping pattern among the first state N1, the second state N2, and the third state N3, additional information indicating the beam size in the first state N1, the beam size in the second state N2, and the beam size in the third state N3 to the UE. The UE may receive, from the base station, the beam hopping pattern among the first state N1, the second state N2, and the third state N3, together with the beam size in the first state N1, the beam size in the second state N2, and the beam size in the third state N3. Based on the beam hopping patterns and beam size information for each of the states, the UE may prevent a radio link failure (RLF) or service interruption in advance.

The beam hopping pattern among the first state N1, the second state N2, and the third state N3, and/or the beam size in the first state N1, the beam size in the second state N2, and the beam size in the third state N3, may be transmitted to the UE through a higher layer signaling message (e.g. RRC signaling message) or system information. Based on this, the higher layer signaling message (e.g. RRC signaling message) or the system information may include the following information.

### <Information Included in the RRC Signaling Message or System Information>

List of neighboring satellite IDs
List of neighboring cell IDs
List of neighboring beam IDs
A DTX pattern and/or DRX pattern for each beam ID
Beam size information for each beam ID (if necessary)

Based on the above descriptions, a method for configuring information to be transmitted from the base station to the UE is described.

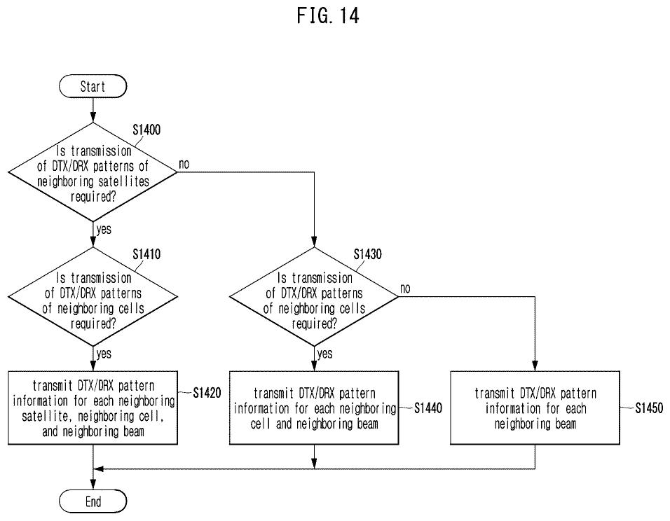

FIG. 14 is a flowchart illustrating operations for a base station to configure information to be provided to a UE according to a beam hopping scheme in an NTN.

In step 1400, the base station may determine whether transmission of DTX patterns and/or DRX patterns of neighboring satellites is needed. Generally, a satellite orbiting the Earth in a low orbit may form an Earth moving cell, and may provide communication services to UEs in cooperation with neighboring satellites for continuity of wireless communication. Therefore, low Earth orbit satellites may require DTX patterns and DRX patterns of neighboring satellites. Geostationary satellites may also require DTX patterns and/or DRX patterns of neighboring satellites to ensure communication continuity for UE(s) located within beams (or cells) at boundaries with beams of other geostationary satellites. On the other hand, UEs located within most of the beam(s) formed by the geostationary satellites may communicate within the geostationary satellites alone. Therefore, in such cases, transmission of DTX patterns and/or DRX patterns of neighboring satellites may be unnecessary. As described above, when transmission of DTX patterns and/or DRX patterns of neighboring satellites is needed, the base station may perform step 1410, and when such transmission is not needed, the base station may perform step 1430.

In step 1410, the base station may determine whether transmission of DTX patterns and/or DRX patterns of neighboring cells is needed. If one cell is composed of multiple beams formed by the satellite, and if the beam(s) corresponding to the center of the cell are considered, transmission of DTX patterns and/or DRX patterns of neighboring cells may generally be unnecessary. In particular, this may be more unnecessary in the case of geostationary satellites. On the other hand, in the case of an Earth moving satellite or even in the case of a geostationary satellite, if one cell is composed of multiple beams formed by the satellite and the beam(s) correspond to the edge of the cell, transmission of DTX patterns and/or DRX patterns of neighboring cells may be necessary. Alternatively, transmission of DTX patterns and/or DRX patterns of neighboring cells may be configured to always occur. When transmission of neighboring cells is required, the base station may perform step 1420.

In step 1420, the base station may configure a DTX pattern and/or DRX pattern per neighboring satellite, neighboring cell, and neighboring beam in a specific message for transmission to the UE. The specific message may be a higher layer signaling message (e.g. RRC signaling message) or a specific SIB as described above.

In step 1430, the base station may determine whether transmission of DTX patterns and/or DRX patterns of neighboring cells to the UE is necessary. A method for the determination in step 1430 may be the same as that of step 1410. When a result of step 1430 indicates that transmission of DTX patterns and/or DRX patterns of neighboring cells to the UE is necessary, the base station may perform step 1440, and when such transmission is not necessary, the base station may perform step 1450.

In step 1440, the base station may configure a DTX pattern and/or DRX pattern per neighboring cell and neighboring beam in a specific message for transmission to the UE. The specific message may be a higher layer signaling message (e.g. RRC signaling message) or a specific SIB as described above.

In step 1450, the base station may configure a DTX pattern and/or DRX pattern per neighboring beam in a specific message for transmission to the UE. The specific message may be a higher layer signaling message (e.g. RRC signaling message) or a specific SIB as described above.

As described above, the base station may configure the specific message and then transmit the message to the UE.

### Sixth Exemplary Embodiment: Method for Providing Information for Channel Estimation During Beam Hopping in NTN

Before describing the sixth exemplary embodiment of the present disclosure, it should be noted that procedures according to the present disclosure may be performed by a base station, satellite, and UE. The UE according to the present disclosure may include all or part of the components described in FIG. 3 above. The UE according to the present disclosure may further include additional components other than the components described in FIG. 3 above. For example, the UE may further include various modules for user convenience, such as a camera module and/or various sensor modules (e.g. geomagnetic sensor, altitude sensor, movement speed sensor, etc.). The UE may also include, if necessary, a device for acquiring location information of the UE through a satellite navigation system (e.g. GNSS).

The base station and/or the satellite may include all or part of the components described in FIG. 3 above. The base station and/or the satellite according to the present disclosure may further include additional components other than the components described in FIG. 3 above.

The base station may further include at least one of an interface for connection with the core network, an interface for connection with another base station, an interface for connection with the gateway, and/or an interface for connection with the satellite. The satellite may further include, for example, an inter-satellite communication device (or inter-satellite communication interface), a communication device between the satellite and the gateway (or a communication interface with the gateway), and/or a communication device for communication with the base station (or a communication interface with the base station).

As described above, in an NTN, a beam hopping scheme may be applied in order to allocate satellite resources to areas with high user density. Through the beam hopping scheme, the base station may utilize satellite resources efficiently. The satellite resources may refer to frequency and power resources. As a result of using the beam hopping scheme, the amount of power and frequency resources used in a particular beam may vary over time. In 3GPP, a TN base station transmits signals at a fixed power over a fixed frequency band, whereas in an NTN, if a beam hopping scheme is applied, a frequency band and a transmission power may be changed.

Generally, a UE receiving signals from a TN base station assumes that the base station always transmits signals (or channels) at a fixed transmission power. Therefore, the UE may estimate a channel between the base station and the UE based on assumption that signals (or channels) are transmitted at a fixed power. However, as described above, if a frequency band and transmission power of a specific beam among beams formed by a satellite in an NTN change, the UE located within the specific beam may be unable to perform accurate channel estimation or may perform erroneous channel estimation.

Accordingly, the present disclosure provides a method in which satellite resource pattern information used together with a beam hopping pattern may be transmitted to the UE through system information, so that the UE can accurately estimate the actual channel condition even if the transmission power and/or frequency band of the satellite beam changes.

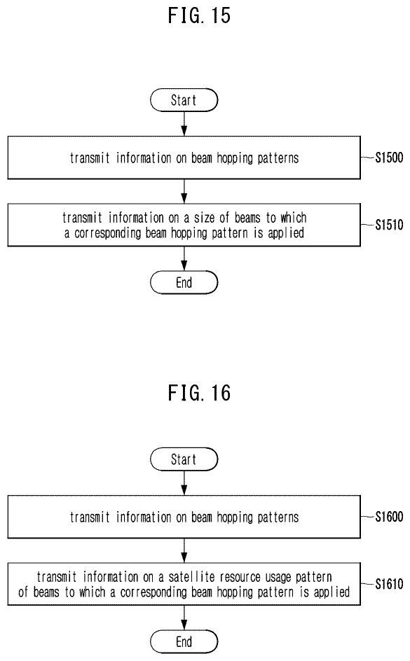

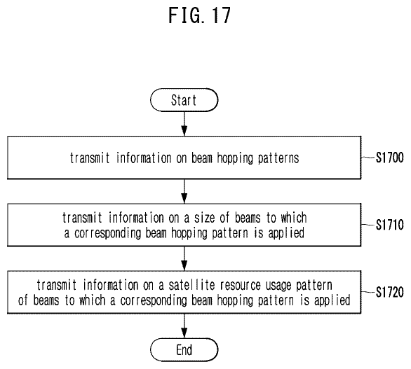

To allow the UE to accurately estimate the actual channel condition even when the transmission power and/or frequency band of the satellite beam changes, one of the methods illustrated in FIG. 15, FIG. 16, or FIG. 17 may be used. The steps of FIGS. 15 to 17 described below are illustrated in sequence for convenience of description, but the order of steps, in other words, the preceding and following operations, may be interchanged. As another method, at least some of the operations in FIGS. 15 to 17 may be performed simultaneously or transmitted through a single message.

FIG. 15 is a flowchart illustrating a first exemplary embodiment of an operation for an NTN base station to configure information to be provided for channel estimation of a UE according to a beam hopping scheme.

In step 1500, the base station may transmit information on beam hopping patterns to the UE. The beam hopping patterns may be separately configured for serving beams (or cells) and adjacent beams (or cells), and the beam hopping patterns may be transmitted to the UE by being configured in a higher layer signaling message (e.g. RRC signaling message) or a specific SIB.

In step 1510, the base station may transmit, to the UE, information on a size of beams to which the beam hopping pattern is applied. For example, a beam hopping pattern of a first beam footprint area and information on a size of the first beam footprint area, the beam hopping pattern of a second beam footprint area and information on a size of the second beam footprint area, etc., may be mapped and transmitted to the UE. The beam hopping pattern and the beam size information (e.g. footprint area size information) may be transmitted to the UE by being configured in a higher layer signaling message (e.g. RRC signaling message) or a specific SIB.

In the example of FIG. 15, steps 1500 and 1510 are described separately, but they may be transmitted to the UE by being included in the same higher layer signaling message. In other words, the information may be transmitted to the UE through a single higher layer signaling message.

FIG. 16 is a flowchart illustrating a second exemplary embodiment of an operation for an NTN base station to configure information to be provided for channel estimation of a UE according to a beam hopping scheme.

In step 1600, the base station may transmit information on beam hopping patterns to the UE. The beam hopping patterns may be separately configured for serving beams (or cells) and adjacent beams (or cells), and the beam hopping patterns may be transmitted to the UE by being configured in a higher layer signaling message (e.g. RRC signaling message) or a specific SIB.

In step 1610, the base station may transmit, to the UE, information on a satellite resource usage pattern of the beams to which the beam hopping pattern is applied. For example, the information on the satellite resource usage pattern of the beams to which the beam hopping pattern is applied may include information on a usage pattern of frequency bands used in the first beam footprint area and/or information on a transmission power of signals transmitted to the first beam footprint area. Such information may be transmitted along with information for adjacent beams. In other words, information on a usage pattern of frequency bands used in the second beam footprint area and/or information on a transmission power of signals transmitted to the second beam footprint area may also be transmitted to the UE.

The information on the satellite resource usage pattern of the beams to which the beam hopping pattern is applied, transmitted in step 1610, may be transmitted to the UE by being configured in a higher layer signaling message (e.g. RRC signaling message) or a specific SIB.

In the example of FIG. 16, steps 1600 and 1610 are described separately, but they may be included in the same higher layer signaling message and transmitted to the UE. In other words, the information may be transmitted to the UE through a single higher layer signaling message.

FIG. 17 is a flowchart illustrating a third exemplary embodiment of an operation for an NTN base station to configure information to be provided for channel estimation of a UE according to a beam hopping scheme.

In step 1700, the base station may transmit information on beam hopping patterns to the UE. The beam hopping patterns may be separately configured for serving beams (or cells) and adjacent beams (or cells), and the beam hopping patterns may be transmitted to the UE by being configured in a higher layer signaling message (e.g. RRC signaling message) or a specific SIB.

In step 1710, the base station may transmit, to the UE, information on a size of beams to which the beam hopping pattern is applied. For example, the beam hopping pattern of the first beam footprint area and the size information of the first beam footprint area, the beam hopping pattern of the second beam footprint area and the size information of the second beam footprint area, etc., may be mapped and transmitted to the UE. The beam hopping pattern and the beam size information (e.g. footprint area size information) may be transmitted to the UE by being configured in a higher layer signaling message (e.g. RRC signaling message) or a specific SIB.

In step 1720, the base station may transmit, to the UE, information on a satellite resource usage pattern of beams to which the beam hopping pattern is applied. For example, the information on the satellite resource usage pattern of the beams to which the beam hopping pattern is applied may include information on a usage pattern of frequency bands used in the first beam footprint area and/or information on a transmission power of signals transmitted to the first beam footprint area. Such information may be transmitted along with information for adjacent beams. In other words, information on a usage pattern of frequency bands used in the second beam footprint area and/or information on a transmission power of signals transmitted to the second beam footprint area may also be transmitted to the UE.

In the example of FIG. 17, steps 1700, 1710, and 1720 are described separately, but they may be included in the same higher layer signaling message and transmitted to the UE. In other words, the information may be transmitted to the UE through a single higher layer signaling message.

It may be determined whether transmission of DTX patterns and/or DRX patterns of neighboring satellites is required. In general, a satellite orbiting the Earth in a low orbit may form an Earth moving cell, and provide communication services to UEs in cooperation with neighboring satellites to ensure continuity of wireless communication. Therefore, the low Earth orbit satellite may require transmission of DTX patterns and DRX patterns of neighboring satellites. In addition, a geostationary satellite may require transmission of DTX patterns and/or DRX patterns of neighboring satellites to ensure continuity of communication for UE(s) located in beams (or cells) at boundaries with beams of other geostationary satellites. On the other hand, in case of a geostationary satellite, UEs located within most of beam(s) formed by the geostationary satellite may be able to communicate within the geostationary satellite alone. Therefore, in such case, transmission of DTX patterns and/or DRX patterns of neighboring satellites may not be required. When transmission of DTX patterns and/or DRX patterns of neighboring satellites is determined to be required as described above, the base station may perform step 1410, and when it is determined not to be required, the base station may perform step 1430.

In step 1410, the base station may determine whether transmission of DTX patterns and/or DRX patterns of neighboring cells is required. When one cell consists of multiple beams formed by a satellite, transmission of DTX patterns and/or DRX patterns of neighboring cells may generally be unnecessary for beam(s) corresponding to the center of the cell among the multiple beams. In particular, such transmission may be even more unnecessary for the geostationary satellite. On the other hand, in the case of an Earth moving satellite or even a geostationary satellite, if one cell consists of multiple beams formed by the satellite, transmission of DTX patterns and/or DRX patterns of neighboring cells may be required for beam(s) corresponding to the edge of the cell. Alternatively, transmission of DTX patterns and/or DRX patterns of neighboring cells may be configured to always be performed. If transmission of such information is required, the base station may perform step 1420.

In step 1420, the base station may configure DTX pattern and/or DRX pattern for each of neighboring satellites, neighboring cells, and neighboring beams in a specific message for transmission to the UE. The specific message may be, as described above, a higher layer signaling message (e.g. RRC signaling message) or a specific SIB.

In step 1430, the base station may determine whether transmission of DTX patterns and/or DRX patterns of neighboring cells to the UE is required. A method for the determination of step 1430 may be the same as that of step 1410. When a result of the determination in step 1430 indicates that transmission of DTX patterns and/or DRX patterns of neighboring cells to the UE is required, the base station may perform step 1440, and if it is not necessary, the base station may perform step 1450.

In step 1440, the base station may configure a DTX pattern and/or DRX pattern for each of neighboring cells and neighboring beams in a specific message for transmission to the UE. The specific message may be, as described above, a higher layer signaling message (e.g. RRC signaling message) or a specific SIB.

In step 1450, the base station may configure a DTX pattern and/or DRX pattern for each of neighboring beams in a specific message for transmission to the UE. The specific message may be, as described above, a higher layer signaling message (e.g. RRC signaling message) or a specific SIB.

As described above, the base station may configure a specific message and then transmit the corresponding message to the UE.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving, from a base station, a first message including information indicating a cell discontinuous transmission (DTX) of a satellite, information indicating a first non-active duration of a first beam formed by the satellite, and information indicating a first active duration of the first beam;
identifying whether a current time is within the first non-active duration based on the first message; and
in response to the current time being a time of transitioning from the first active duration to the first non-active duration, configuring not to receive control information and traffic from the base station,
wherein the first non-active duration is a duration in which the first beam is in an off state, and the first active duration is a duration in which the first beam is in an active traffic state.

2. The method according to claim 1, wherein the information indicating the first non-active duration includes a first time for transitioning from the first active duration to the first non-active duration and a first period for maintaining the first non-active duration, and the information indicating the first active duration includes a second time for transitioning from the first non-active duration to the first active duration and information on a second period for maintaining the first active duration.

3. The method according to claim 1, further comprising: in response to the current time being a time of transitioning from the first non-active duration to the first active duration, configuring to receive control information and traffic from the base station.

4. The method according to claim 1, further comprising:
in response to the first message including information indicating a cell discontinuous reception (DRX) for the first beam, identifying whether the current time is a time of transitioning from the first active duration to the first non-active duration; and
in response to the current time being a time of transitioning from the first active duration to the first non-active duration, configuring not to perform an initial access procedure through a random access channel (RACH), transmission in a configured grant (CG) resource configured by the base station, transmission of a scheduling request (SR), periodic channel state information (CSI) reporting, semi-persistent CSI reporting, periodic sounding reference signal (SRS) transmission, and semi-persistent SRS transmission.

5. The method according to claim 4, further comprising: in response to the current time being a time of transitioning from the first non-active duration to the first active duration,
configuring to perform an initial access procedure through a RACH, transmission in a CG resource configured by the base station, transmission of an SR, periodic CSI reporting, semi-persistent CSI reporting, periodic SRS transmission, and semi-persistent SRS transmission.

6. The method according to claim 1, further comprising:
in response to the first message further including information indicating a second non-active duration of the first beam, identifying whether the current time is a time of transitioning from the first active duration to the second non-active duration; and
in response to the current time being a time of transitioning from the first active duration to the second non-active duration, configuring to receive only control information from the base station,
wherein the second non-active duration is a duration in which the first beam transmits only a common message, and the information indicating the second non-active duration includes a third time for transitioning from the first active duration to the second non-active duration and information on a third period for maintaining the second non-active duration.

7. The method according to claim 6, further comprising: in response to the current time being a time of transitioning from the second non-active duration to the first active duration,
configuring to receive control information and traffic from the base station,

8. The method according to claim 1, further comprising:
in response to the first message including information indicating a cell DRX of the first beam and information indicating a second non-active duration of the first beam, identifying whether the current time is a time of transitioning from the first active duration to the second non-active duration; and
in response to the current time being a time of transitioning from the first active duration to the second non-active duration, configuring not to perform transmission on a CG resource configured by the base station,
wherein the second non-active duration is a duration in which the first beam transmits only a common message, and the information indicating the second non-active duration includes a fourth time for transitioning from the first active duration to the second non-active duration and information on a fourth period for maintaining the second non-active duration.

9. The method according to claim 1, further comprising:
in response to the first message including information indicating a second active duration of the first beam, identifying whether the current time is a time of transitioning from the first non-active duration to the second active duration; and
in response to the current time being a time of transitioning from the first non-active duration to the second active duration, configuring to perform synchronization signal block (SSB) reception, system information block (SIB) reception, paging, physical downlink control channel (PDCCH) and semi-persistent scheduling (SPS) monitoring,
wherein the second active duration is a duration in which the first beam transmits only a common message, and the information indicating the second active duration includes a fifth time for transitioning from the first non-active duration to the second active duration and information on a fifth period for maintaining the second active duration.

10. The method according to claim 1, further comprising:
in response to the first message including information indicating a cell DRX of the first beam and information indicating a second active duration of the first beam, identifying whether the current time is a time of transitioning from the first non-active duration to the second active duration; and
in response to the current time being a time of transitioning from the first non-active duration to the second active duration, configuring to perform an initial access procedure using a RACH, SR transmission, periodic CSI reporting, semi-persistent CSI reporting, periodic SRS transmission, and semi-persistent SRS reporting,
wherein the second active duration is a duration in which the first beam transmits only a common message, and the information indicating the second active duration includes a fifth time of transitioning from the first non-active duration to the second active duration and information on a fifth period for maintaining the second active duration.

11. A method of a base station, comprising:
transmitting, to a user equipment (UE), a first message including information indicating a cell discontinuous transmission (DTX) of a satellite, information indicating a first non-active duration of a first beam formed by the satellite, and information indicating a first active duration of the first beam;
turning off the first beam when transitioning from the first active duration to the first non-active duration; and
transmitting control information and traffic to the UE through the first beam when transitioning from the first non-active duration to the first active duration,
wherein the first non-active duration is a duration in which the first beam is in an off state, and the first active duration is a duration in which the first beam is in an active traffic state.

12. The method according to claim 11, wherein the information indicating the first non-active duration includes a first time for transitioning from the first active duration to the first non-active duration and a first period for maintaining the first non-active duration, and the information indicating the first active duration includes a second time for transitioning from the first non-active duration to the first active duration and information on a second period for maintaining the first active duration.

13. The method according to claim 11, further comprising: transmitting only control information to the UE when transitioning from the first active duration to a second non-active duration,
wherein the first message further includes information indicating the second non-active duration for the first beam, and the information indicating the second non-active duration includes a third time for transitioning from the first active duration to the second non-active duration and information on a third period for maintaining the second non-active duration.

14. The method according to claim 13, further comprising: receiving uplink signals from the UE, excluding an uplink signal in a CG resource configured by the base station, when transitioning from the first active duration to the second non-active duration,
wherein the first message further includes information indicating a cell DRX of the first beam.

15. The method according to claim 11, further comprising: transmitting an SSB, an SIB, paging, a PDCCH, and an SPS through the first beam after transitioning from the first non-active duration to a second active duration,
wherein the first message further includes information indicating the second active duration, and the information indicating the second active duration includes a fourth time for transitioning from the first active duration to the second active duration and information on a fourth period for maintaining the second active duration.

16. A user equipment (UE) comprising at least one processor, wherein the at least one processor causes the UE to perform:
receiving, from a base station, a first message including information indicating a cell discontinuous transmission (DTX) of a satellite, information indicating a first non-active duration of a first beam formed by the satellite, and information indicating a first active duration of the first beam;
identifying whether a current time is within the first non-active duration based on the first message; and
in response to the current time being a time of transitioning from the first active duration to the first non-active duration, configuring not to receive control information and traffic from the base station,
wherein the first non-active duration is a duration in which the first beam is in an off state, and the first active duration is a duration in which the first beam is in an active traffic state.

17. The UE according to claim 16, wherein the information indicating the first non-active duration includes a first time for transitioning from the first active duration to the first non-active duration and a first period for maintaining the first non-active duration, and the information indicating the first active duration includes a second time for transitioning from the first non-active duration to the first active duration and information on a second period for maintaining the first active duration.

18. The UE according to claim 16, wherein the at least one processor causes the UE to perform: in response to the current time being a time of transitioning from the first non-active duration to the first active duration, configuring to receive control information and traffic from the base station.

19. The UE according to claim 16, wherein the at least one processor causes the UE to perform: in response to the first message including information indicating a cell discontinuous reception (DRX) for the first beam, identifying whether the current time is a time of transitioning from the first active duration to the first non-active duration; and
in response to the current time being a time of transitioning from the first active duration to the first non-active duration, configuring not to perform an initial access procedure through a random access channel (RACH), transmission in a configured grant (CG) resource configured by the base station, transmission of a scheduling request (SR), periodic channel state information (CSI) reporting, semi-persistent CSI reporting, periodic sounding reference signal (SRS) transmission, and semi-persistent SRS transmission.

20. The UE according to claim 19, wherein the at least one processor causes the UE to perform: in response to the current time being a time of transitioning from the first non-active duration to the first active duration, configuring to perform an initial access procedure through a RACH, transmission in a CG resource configured by the base station, transmission of an SR, periodic CSI reporting, semi-persistent CSI reporting, periodic SRS transmission, and semi-persistent SRS transmission.
